(19) United States
(12) Patent Application Publication
(10) Pub. No.: US 2023/0302489 A1
(43) Pub. Date: Sep. 28, 2023

(54) TEMPLATE-FREE METHOD FOR MANUFACTURING OF SEMI-REGULAR FUNCTIONAL MICRO-STRUCTURED INTERFACES IN VISCOELASTIC MATERIALS

(71) Applicant: North Carolina State University, Raleigh, NC (US)

(72) Inventors: Jong Eun Ryu, Raleigh, NC (US); Chang-Jin Kim, Raleigh, NC (US); Mohammed A. Zikry, Raleigh, NC (US)

(21) Appl. No.: 18/125,617

(22) Filed: Mar. 23, 2023

Related U.S. Application Data
(60) Provisional application No. 63/322,799, filed on Mar. 23, 2022.
(60) Provisional application No. 63/453,883, filed on Mar. 22, 2023.

(51) Int. Cl. B05D 3/12

(52) U.S. Cl. CPC B05D 3/12; B05D 2506/10; B05D 2518/10; B05D 2301/00

(57) ABSTRACT

Various examples are related to template-free methodologies to obtain “semi-regular” micro/nano-textures utilizing ribbing instability behavior in viscoelastic polymers. The methodologies offer low manufacturing cost and scalability for real-world applications. In one example, a method includes forming a viscoelastic material coating and forming micro-scale and/or nano-scale 3D features on a surface of the viscoelastic material coating. The micro-scale and/or nano-scale 3D features can be formed under shearing stress using a roll-to-roll process without a template. The texture periodicity and height in the polymer coat film can be adjusted through the roll coating process parameters and/or the polymer composite behavior.

### CROSS REFERENCE TO RELATED APPLICATIONS

This application claims priority to, and the benefit of, co-pending U.S. provisional applications entitled “Template-Free Method for Manufacturing of Semi-Regular Functional Micro-Structured Interfaces in Viscoelastic Materials” having Ser. No. 63/322,799, filed Mar. 23, 2022, and Ser. No. 63/453,883, filed Mar. 22, 2023, all of which are hereby incorporated by reference in their entirety.

### STATEMENT REGARDING FEDERALLY SPONSORED RESEARCH OR DEVELOPMENT

This invention was made with government support under grant numbers CMMI2030404 and CMMI2031558 awarded by the National Science Foundation. The government has certain rights in the invention.

### BACKGROUND

Microstructured interfaces can provide functionality due to the geometry of the surface. Examples include light-matter interactions, super-hydrophobicity, self-cleaning, anti-bacterial, radiative, and convective cooling, and drag reduction. Because of their ability to adapt to the environment, many examples of complex structures in biological systems remain a significant source of inspiration in the development of fundamental scientific principles. Nature remains far ahead of human-developed technologies, as biological systems have been using micro-nano scale structures to produce unique functionalities for millions of years. For example, lotus leaves have a specific surface roughness with modified surface chemistry to enable self-cleaning as it does not get dirty even though it grows in a muddy environment. A shark is one of the best swimmers in the ocean. It has a unique skin morphology with periodic microstructures that modify the near-wall vorticity during turbulent flow reducing skin friction. In contrast, Namib desert beetles harvest water from the fog with superhydrophobic-superhydrophilic microstructures that allow them to survive in harsh dry weather. These unique surface topographies with useful functionalities have inspired the development of biomimetic micro-nano structures for applications in self-cleaning surfaces, drinking water harvesting from fog, friction reduction in solid-solid interfaces, and hydrodynamic drag reduction in ships.

### SUMMARY

Linear periodic microstructures are of great importance in a variety of applications including drag-reduction, biofouling, self-cleaning, and superhydrophobicity. However, practical applications of such surfaces need mass manufacturing techniques which to date are highly challenging. Aspects of the present disclosure are related to methodologies for template-free production of micro/nano-textures. A simple template-free scalable manufacturing technique is demonstrated to fabricate linearly periodic microstructure by controlling the so-called ribbing defects in the forward roll coating. A viscoelastic polymer nanocomposite with tailored properties was synthesized and utilized as the coating material. By the adjustable ribbing parameters in roll-coating variable periodicity of the linear microstructures was obtained with 114-700 μm spacing. The microstructure also showed a linear to random microstructure transition as the instabilities increased. The manufactured surface also holds a high Wenzel roughness factor from 1.6 to 3.6 which results in water contact angles of 128° to 158°. The linear microstructure films can have important applications in mass manufacturing of drag reduction surfaces, whereas the high aspect-ration random microstructure films can have applications in superhydrophobic, self-cleaning, anti-icing, and anti-biofouling surfaces.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A illustrates an example of composite paste formulation of CNT-PDMS with varying wt %, in accordance with various embodiments of the present disclosure.

FIGS. 1B-1D illustrate examples of a two roll coating machine that can be used for template-free production of micro/nano-textures, in accordance with various embodiments of the present disclosure.

FIGS. 2A-2E illustrate examples of viscoelastic properties of PDMS materials and CNT-PDMS composites, in accordance with various embodiments of the present disclosure.

FIGS. 3A-3E illustrate examples of examples of ribbing instability of PDMS in CFD simulations, in accordance with various embodiments of the present disclosure.

FIGS. 4A-4C illustrate examples of ribbing instability of PDMS under various processing conditions, in accordance with various embodiments of the present disclosure.

FIGS. 5A-5D illustrate examples of experimental data of PDMS ribbing wavelengths versus various process conditions, in accordance with various embodiments of the present disclosure.

FIG. 6 includes scanning electron microscope (SEM) images illustrating examples of fabricated CNT-PDMS composite samples, in accordance with various embodiments of the present disclosure.

FIGS. 7A and 7B illustrate laser confocal microscope imaging and characteristics of a fabricated sample, in accordance with various embodiments of the present disclosure.

FIGS. 8A-8C illustrate examples of water contact angle measurements for the fabricated CNT-PDMS composite samples, in accordance with various embodiments of the present disclosure.

FIGS. 9A and 9B illustrate examples of CFD simulation results for roll-coating of 3.5 wt % CNT-PDMS, in accordance with various embodiments of the present disclosure.

FIGS. 10A-10D illustrate hydrodynamic drag testing and results, in accordance with various embodiments of the present disclosure.

FIG. 11 illustrates and example of sheet resistance of CNT-PDMS composite samples, in accordance with various embodiments of the present disclosure.

FIGS. 12A and 12B illustrate scratch test results of (a) a 3.5 wt % CNT-PDMS sample and (b) a PDMS-Sylgard 184 sample, in accordance with various embodiments of the present disclosure.

FIGS. 13A and 13B illustrate an example of a manufacturing process for SiO₂-PDMS composite film, in accordance with various embodiments of the present disclosure.

FIGS. 14A-140 illustrate an example of a solar panel film test setup, in accordance with various embodiments of the present disclosure.

FIGS. 15A-15D illustrate examples of water contact angle and laser conformal microscopy results for SiO₂-PDMS composite film, in accordance with various embodiments of the present disclosure.

FIGS. 16A and 16B illustrate examples of Uv-Vis spectroscopy results for SiO₂-PDMS composite film, in accordance with various embodiments of the present disclosure.

FIGS. 17A-17B and 18A-18B illustrate temperature difference results for SiO₂-PDMS composite film, in accordance with various embodiments of the present disclosure.

FIGS. 19A-19E illustrate an example of a manufacturing process for a bilayer nanocomposite microstructure photonic coating, in accordance with various embodiments of the present disclosure.

FIGS. 20A-20D illustrates examples of passive radiative cooling and water contact angle results of the bilayer nanocomposite microstructure photonic coating, in accordance with various embodiments of the present disclosure.

FIGS. 21A-21J illustrate examples of reflectance results of the bilayer nanocomposite microstructure photonic coating, in accordance with various embodiments of the present disclosure.

FIGS. 22A-22D illustrate an example of an outdoor cooling power measurement setup, in accordance with various embodiments of the present disclosure.

FIGS. 23A-23C illustrate an example of potential building cooling energy savings using the bilayer nanocomposite microstructure photonic coating, in accordance with various embodiments of the present disclosure.

### DETAILED DESCRIPTION

Functional micro and nano structures have mainly been fabricated by means of templates generated by a photolithography process to obtain the desired geometry. However, the photolithographic process is prohibitively expensive and is not scalable for large area surfaces needed for real-world applications. Disclosed herein are various examples related to a template-free method to obtain “semi-regular” micro/nano-textures by utilizing the ribbing instability behavior in viscoelastic polymers due to shearing stresses, offering low manufacturing cost and scalability for real-world applications. The texture periodicity and height in the polymer coat film can be adjusted through the roll coating process parameters and the polymer composite behavior.

A roll-to-roll process without a template can be used to make micro/nano-scale 3D features with this semi-regular geometry. The width of the roller can be adjusted to produce semi-regular structures on a large area substrate. Applications can include superhydrophobic surfaces in large scale (offering self-cleaning, anti-bacterial, and/or anti-biofouling), electromagnetic and radiation shielding coatings, daytime passive cooling by enhanced radiation emission, among others. Reference will now be made in detail to the description of the embodiments as illustrated in the drawings, wherein like reference numbers indicate like parts throughout the several views.

While various technologies including lithography, laser cutting, micro-coining, 3D printing, and bio-pattern imprinting have been utilized to fabricate these micro-nano structures, there are critical limitations in practical applications as most of these methods are complex, expensive, and time-consuming, making them unsuitable for mass-manufacturing. For example, lithography techniques have been implemented to manufacture periodic linear micro-trench surface that has successfully shown a drag reduction effect in open water turbulent flows. However, the surface samples were made from silicon wafers using microelectromechanical systems (MEMS) technology, limiting them to the size of the wafer—far smaller than a real-life boat or ship. Manufacturing these micro-patterned structures in a low-cost scalable process is important for feasible, practical applications.

The desirability of periodic micro-structures has provided motivation to look more insightfully into a common roll-coating defect known as ribbing instability. The ribbing instability is an interesting phenomenon as spatially periodic patterns form transverse to the roll-coating direction, where spatially periodic patterns appear transverse to the roll-coating direction. During the roll-coating process, a positive pressure gradient is developed in the downstream meniscus of the coating fluid. The flow becomes unstable when the pressure gradient exceeds a critical value, and a finger-like growth is observed. Conventionally, these patterns are undesirable in roll-coating applications such as painting, applying adhesive, or preparing functional films for optical and electrical applications. However, careful control of these ribbing patterns can assist in replicating periodic microstructures obtained by other aforementioned methods.

The ribbing behavior of the Newtonian and non-Newtonian fluids has been studied through experimental and computational models to minimize roll-coating defects. The ribbing periodicity or wavelength (Wλ_{ribbing}) and amplitude have been studied and found to have a strong relationship with material properties as well as process parameters, including, e.g., the surface energy (γ), viscosity (η), roller radius (R), roller distance or gap (d), and roller speed (U). Although most of the liquids utilized in the coating technologies are non-Newtonian, most of the study was conducted for the ribbing instability with a Newtonian fluid.

For a Newtonian fluid, the onset condition of the ribbing instability was found describable by two dimensionless parameters: the capillary number Cₐ=η*U/γ and the geometric factor R/d. The critical capillary number C*ₐ showed a linear proportionality with the geometric factor Rid for Newtonian fluids. On the other hand, the critical capillary number for non-Newtonian fluids is much lower than for Newtonian fluids. However, unlike the Newtonian fluid, the theoretical prediction of the C*ₐ in the viscoelastic fluid is not obtainable. There remains a lack of understanding of how the ribbing occurs in coating applications. The elasticity can be controlled with the concentration of polymer molecules in a Newtonian fluid (glycerol/water) and similar trends in the C*ₐ and the normal stress parallel to the flow can be shown as the polymer concentration increases. The results imply that the behavior of the viscoelastic fluid increases the stress in the flow direction by restricting the flow and causes the ribbing instability at a slower roller speed, i.e., a lower capillary number. According to computational simulations, at any given Cₐ, there is a Weissenberg number Wᵢ above which the flow becomes unstable. Research on non-Newtonian fluids has focused on identifying the critical capillary numbers or threshold conditions to initiate the instabilities, however the fluid propagation and ribbing formation beyond the onset conditions have not been explored.

Coating with viscoelastic fluids tends to be more complex as these materials exhibit complex rheological phenomena, including shear-thinning, shear-thickening, and thixotropic behavior. Unlike the typical coating applications, it is desirable to retain the deformed shape when the rollers come at a stop. However, the materials tend to flatten due to surface tension. This can be overcome by tailoring the balance between surface energy and the viscosity of the coating paste. Though, increasing the viscosity of the paste makes the ribbing behavior more unpredictable.

A roll-coating method has the potential of producing a large surface micro-patterned area by manipulating the ribbing-instability phenomenon. However, there remains a knowledge gap in understanding the ribbing behavior of non-Newtonian paste. An in-depth investigation on the physical properties of the roll-coating pastes and how it influences the ribbing instabilities in a roll-coating process can help achieve scalable manufacturing of periodic micropatterns surface. These surfaces can significantly impact drag reduction, superhydrophobic, self-cleaning, anti-icing coatings, anti-biofouling, biological sensors, and radiative cooling applications.

Unlike the roll-coating applications, controlling the process parameters to manufacture periodic microstructures by controlling the instabilities beyond the onset conditions is examined here. As observed, for most coating materials the ribbing patterns tend to flatten when the roller stops, as the surface tension dominates over viscosity. However, retaining the deformed shape when the rollers stop is necessary to manufacture the periodic microstructures. The surface flattening can be avoided by tailoring the coating liquid's viscoelastic properties. The viscoelasticity of the polymers (e.g., PDMS, polyurethane, polyethylene, or polyamide) can be engineered by nanoparticle addition. The desired materials can behave only like a fluid above the yield stress but act like a solid when the stress is unloaded. The inclusions' volume fraction and geometry can influence the composite's rheological properties. Notably, composites with cylindrical or high aspect ratio nanoparticles are more likely to possess yield stress than spherical particles.

In this disclosure, the ribbing phenomenon of a Newtonian fluid in forward roll coating process parameters is first studied as a reference. The ribbing formation of polydimethylsiloxane (PDMS, Sylgard 184) in a forward roll coating for various process parameters was investigated. The finger-like ribbing was observed during the roll coating. However, when the rollers stopped, the liquid surface flattened due to the surface tension. It was found that the viscoelastic properties of the elastomer can be manipulated by nanoparticle inclusion, which can result in a viscoelastic non-Newtonian composite paste. This can help balance the viscous force to the surface energy forces to avoid surface flattening when the rollers come to stop. Based on the insights from the reference Newtonian fluid elastomer, the composite paste can be utilized in the roll-coating process to manufacture linearly periodic microstructures.

A viscoelastic composite paste was formulated by adding cylindrical nanoparticles (carbon nanotubes, CNTs) to PDMS. This helped to achieve a yield behavior and avoid surface tension-driven flattening. Utilizing the composite paste, linearly periodic microstructures were manufactured by the roll-coating process. The physical properties of the coating paste and computational fluid dynamics (CFD) analysis of the roll-coating parameters helped to successfully manipulate the ribbing instabilities to manufacture periodic microstructures. The manufactured samples were then applied to a miniature boat to measure the drag reduction and load testing. In addition, the mechanical and electrical properties of the CNT-PDMS composite were also evaluated for multifunctionality and robustness.

Methodology

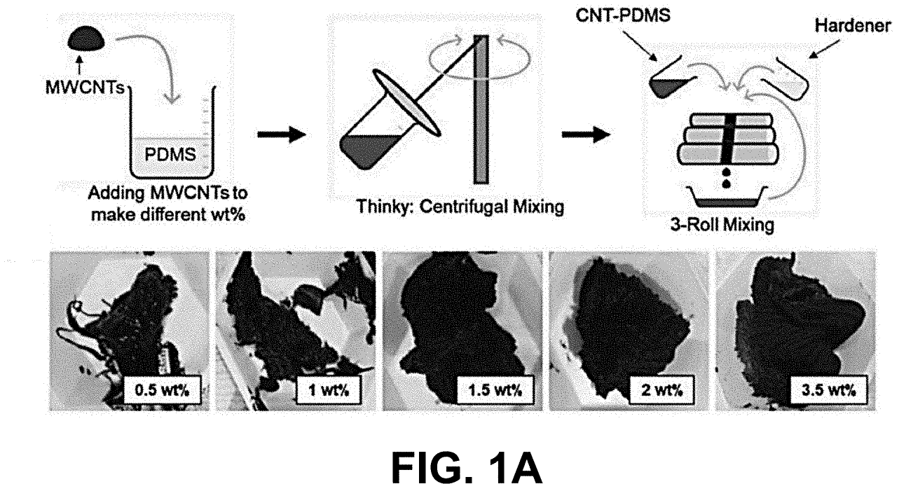

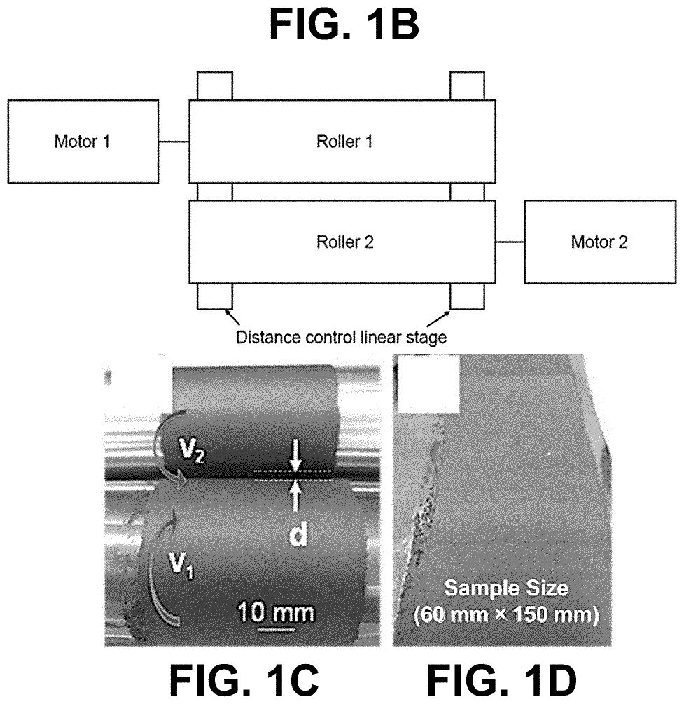

Coating materials preparation. A nanocomposite paste was synthesized using a polydimethylsiloxane elastomer kit (e.g., PDMS Sylgard 184, Dow chemicals) and multi-walled carbon nanotube (e.g., CNT, 6-9 nm diameter, and 100-200 μm length). The PDMS and CNT were initially mixed utilizing a universal planetary mixer for 10 minutes. Next, the hardener was introduced as 10:1 ratio with the PDMS, and the combined mixture was addressed to a high-shear three-roll milling machine. The roller distances were reduced gradually, and the materials were passed multiple times to ensure adequate dispersion and homogenization of the CNTs. The CNT wt % were varied to get composite pastes with tailored rheological properties. FIG. 1A illustrates the composite paste formulation, including images of the processed CNT-PDMS with varying wt %.

Forward roll coating. A two-roll coating machine was utilized to fabricate samples and analyze the ribbing behavior. FIG. 1B illustrates an example of a two-roll coating machine used for the fabrication. The radius (R) of each roller was 25.4 mm. The rollers can run with independent motors as the angular speed can be controlled within the range of 0-120 rpm. A removable polyimide sleeve was inserted on roller #1 to transfer the composite film after the roll-coating. The coating materials were inserted between two rollers and were introduced to different process conditions by controlling the roller speeds U₁, U₂, and the roller distance or gap of d. FIG. 1C is an image illustrating an example of the forward roll coating of composite paste. Finally, the composite film with micro-structure was oven cured at 125° C. for 25 minutes. FIG. 1D is an image of an examples of a fabricated sample after heat-cure.

Rheology measurement. Steady and dynamic oscillatory rheological experiments were conducted on a TA Instruments Discovery Hybrid-3 rheometer with an 8 mm cross-hatched parallel plate geometry, using a 1000 μm⁻² mm measuring gap. Frequency sweeps were performed from 0.1-627 Hz at an oscillatory strain of 1%, determined to be within the linear viscoelastic regime according to oscillatory strain sweeps. The lower limit of frequencies for the low modulus sample(s) was often dictated by the transducer limit of the rheometer. Tests were repeated in triplicate, and standard errors were <5%. Average values are reported. The frequency sweep data were later utilized to get steady shear-rate vs viscosity data based on the Cox-Merz rule.

Surface morphology characterization. The surface roughness and waviness of the samples were characterized by a non-contacting laser scanning confocal microscope (e.g., Keyence VK-X1100, 0.5 nm height resolution, and 1 nm width resolution). Several roughness descriptors such as the Wenzel roughness factor (r), the density of peaks (Spd), and arithmetic mean wavelength (Wλa) were evaluated from the laser confocal data. The surface morphology was also investigated with a high-resolution scanning electron microscope (e.g., FEI Verios 460 L).

Contact angle measurement. Contact angle measurements were conducted with a Ramé-hart goniometer (e.g., model 250) at ambient temperature (e.g., 22-25° C.). A water droplet of 2 μL was carefully deposited onto the sample surface, and the syringe was withdrawn immediately. The water droplet images at 5 different locations for each of the samples were taken by a charge-coupled device camera and 150 W fiber optic illuminator. Finally, the water contact angle was measured using the low bong axisymmetric drop shape analysis plugin of ImageJ software.

Results

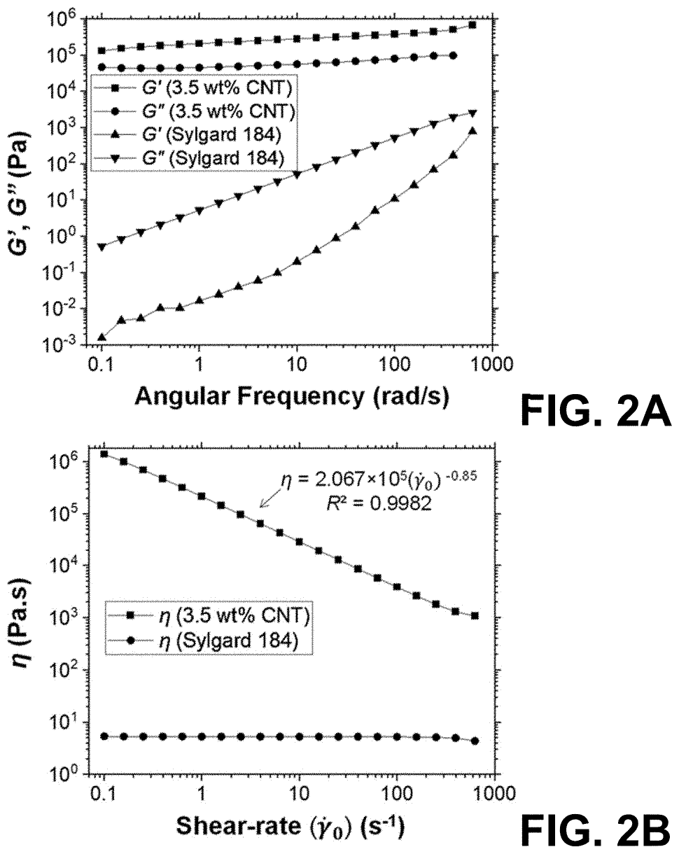

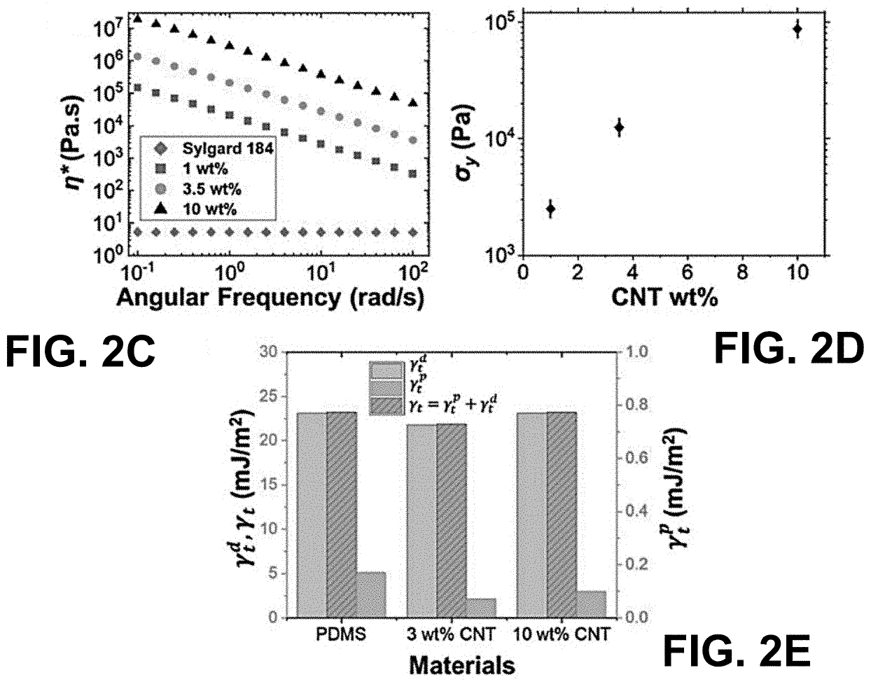

Rheological properties of PDMS vs composite paste. The viscoelastic properties of the materials were plotted in FIGS. 2A and 2B. FIG. 2A illustrates examples of storage modulus (G′) and loss modulus (G″) vs angular frequency sweep; and FIG. 2B illustrates examples of viscosity (η) vs the shear-rate data based on the Cox-Merz rule. The PDMS (Sylgard 184) showed 10-3 to 10-′ Pa storage modulus and 1 to 102 Pa loss modulus from 0.1-100 rad/s angular frequency. As observed, the loss modulus is consistently higher compared to the storage modulus, which signifies that the PDMS material was in the viscoelastic liquid region. However, compared to the CNT-PDMS composites, the viscosity (η) varied between 5.3-5.2 Pa·s, and change was minimal for the shear rate of 0.1-100 1/s. The 3.5 wt % CNT-PDMS showed a storage modulus (G′) of 1.3×10⁵−6.7×10⁵ Pa and loss modulus (G″) 4.6×10⁴−9.7×10⁴ Pa. In both cases, the storage modulus increases with an increasing trend; the material behaves rubbery in this region. The viscosity of both 3.5 wt % CNT-PDMS shows a shear-thinning response viscosity decreases with shear rate. The viscosity was well fitted into power-law as the viscosity was defined by 2.067×10⁵(\dot{γ}₀)^{-0.85} where \dot{γ}₀ is the shear rate (s⁻¹).

FIG. 2C shows the complex viscosity (η*) of the PDMS-only sample as a function of angular frequency. The sample was found to be Newtonian with a low viscosity consistent with a low molecular weight polymer. The elastic (G′) and viscous modulus (G″) also reveal a frequency-dependent behavior with G″ dominating G′ indicative of viscoelastic material. When CNTs are incorporated into the PDMS, both the elastic and viscous moduli increase by several orders of magnitude. The elastic modulus becomes larger than the viscous modulus, and both are independent of frequency, characteristic of 3D sample spanning networks. Such microstructure formation via physical interlocking between the CNTs and PDMS can suppress the molecular motions of the polymer chains.

In FIG. 2C, it is noted that the complex viscosity of the CNT-loaded samples exhibits a power-law behavior with respect to frequency. The absence of a Newtonian regime is consistent with microstructure formation. All samples show a significantly enhanced value compared to PDMS alone; more importantly, a slope approximating −1 was observed, suggestive of the presence of yield stress. Similar trends in this type of system have been measured, with high modulus and yield stress values attributed to nanotube clusters which jam and cause internal percolation within the polymer matrix.

In addition to the moduli increase, the physical interlocking of the CNT in the PDMS matrix results in yield stress, which increases with CNT loading. FIG. 2D illustrates yield stress (σ_{y}) of the composites versus CNT wt %. The elastic stress approach was used to measure the yield stress in this plot. The yield stress prevents the paste from flowing until a specific stress is met, beneficial as surface features can be preserved postprocessing. It was also confirmed in a subsequent experiment that PDMS could not retain the ribbing shape due to lack of yield behavior, whereas CNT-PDMS samples prevent surface-tension-driven flattening.

Apparent Surface Energy. The dynamics between surface energy and viscosity of the fluid, often described as a capillary number in roll coating, have an important role in ribbing instability. The surface energy (γ) of PDMS has been studied. The dispersive component of surface energy was measured 17.5-21.7 mJ m⁻² by several methods such as pendant drop, polymer melt, and liquid contact angle measurements approach. The polar component was negligible compared to the dispersive component, as the value ranged from 0.8 to 2.3 mJ m⁻². The surface energy of multiwall CNTs was also measured by the Washburn, Wilhelmy, and scanning electron microscopy (SEM) contact angle measurements method. The dispersive component of the surface energy of CNTs with 90%-99% purity was 23-37 mJ m⁻², whereas the polar part was 0-16.1 mJ m⁻². However, the CNT-PDMS composite has not been studied previously.

Three reference liquids, water, diiodomethane (DIM), and ethylene glycol (EG), were used to measure contact angles in several flat samples of the composite materials. The data were fitted in Owens-Wendt model, and the apparent surface energy was evaluated. A summary of the apparent surface energy is shown in FIG. 2E, with the surface energy components of the materials based on the fitting. The addition of CNTs showed minimal impact on the surface energy of the PDMS. The polar component (γₜ^{p}) for each test material was low, 0.07-0.17 mJ m⁻², and the dispersive component (γₜ^{d}) was dominant in all cases. The total surface energy (yt) for PDMS, 3 wt % CNT, and 10 wt % CNT, was found 23.23, 21.85, and 23.2 mJ m⁻² based on the Owens-Wendt model. The surface energy of the PDMS was found to be in good agreement with the prior studies validating the experimental method. As the surface energy of the composite appears to be dominant by the PDMS, the only scope to tune to dynamics between viscous force and surface energy would rely on tuning the viscoelastic properties as observed in the prior section.

CFD Simulation of Roll-Coating of PDMS. A fundamental limitation in all prior studies related to roll-coating of non-Newtonian materials was defining the process parameters during the roll coating, such as the capillary number C*ₐ, shear rate (\dot{γ}), and wall shear stress (τ_{w}). The shear rate-dependent viscoelastic behavior of the coating materials is usually obtained by a rheometer. However, the roll-coating instruments are not intrinsically viscometric, as they do not have the necessary sensors. Thus, the exact viscosity of the coating paste during the roll-coating process is unknown as the associated shear rate is also unknown. Estimating the capillary number relies on either assuming a constant viscosity or estimating the shear rate based on the velocity of the rollers, which results in inaccurate Cₐ. Accurate measurement of the shear rate can be obtained by finite element analysis to determine the fluid velocity profile gradient during the roll-coating process.

Hence, a CFD simulation was conducted to develop an effective method to determine the unknown process parameters, including the pressure gradient in the fluid flow direction (dp/dx), fluid flow velocities (Vₓ), shear rate (\dot{γ}), and wall shear stress (τ_{w}). A commercial software FLOW-3D was utilized to investigate the effect of roll-coating speeds (U) and rollers distance (d) to the parameters mentioned above. Both rollers were kept at the same speed for each simulation (U₁=U₂=U).

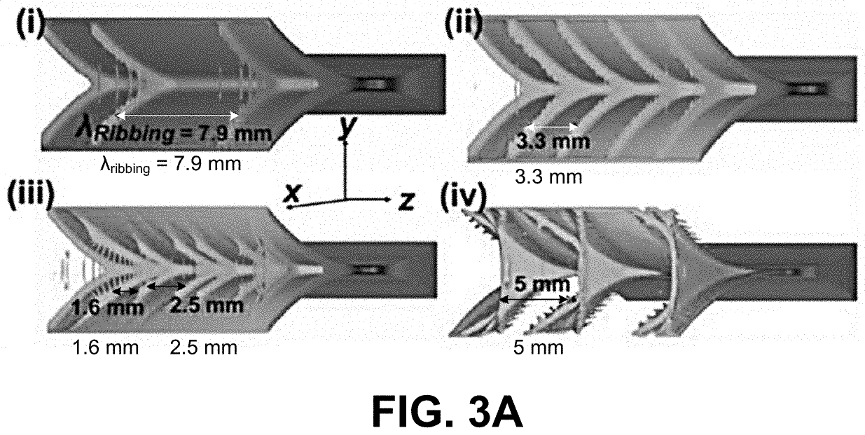

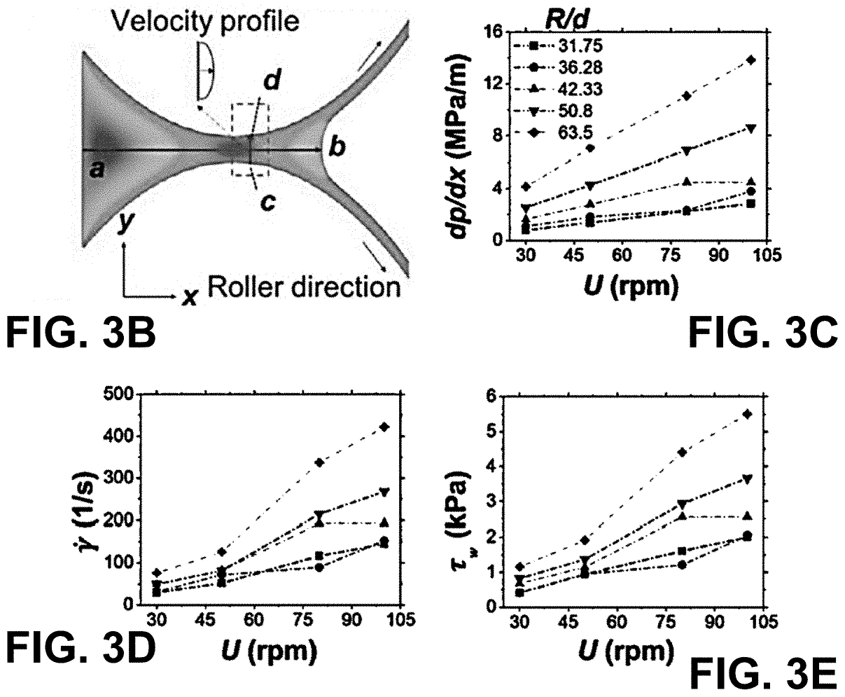

The ribbing formation was observed in the CFD simulation of roll-coating under various process conditions. First, a 3D simulation was conducted at a fixed roller speed of U=40 rad s⁻¹ for different roller distances (d). A dimensionless parameter (R/d) was defined, where R is the roller radius. FIG. 3A illustrates the ribbing instability observed for roller speeds of 40 rad s⁻¹ and R/d (i) 63.5 (ii) 84.67 (iii) 101.6, and (iv) 127. The ribbing wavelength (λ_{ribbing}) is initially observed to be equally spaced for each condition and reduces from 7.9 to 3.3 mm as R/d increases from 63.5 to 84.67. However, as the R/d further increases to 101.6, the periodicity becomes irregular as λ_{ribbing} observed between 1.6 and 2.5 mm. Finally, with an R/d of 127, the ribbing patterns show further distortion and λ_{ribbing} increases to 5 mm. The filamentation phenomenon was also observed in the 3D simulation.

The surface tension-driven 3D model in FLOW-3D is highly computationally demanding. As a remedy, further investigation on the pressure gradient, shear rate, and shear stress during the roll-coating was conducted in two-dimensions. The cross-sectional view of the fluid profile showing the velocity and pressure gradient at the roller's interface is shown in FIG. 3B. The pressure gradient (dp/dx) and fluid velocity (Vₓ) are observed along the x-axis (a-b direction). As the rollers begin to rotate, a pressure differential is generated, with high pressure on the upstream, which drives the fluid flow. The pressure differential increases with an increase in R/d. The higher-pressure differential also causes a higher V, in the a-b direction. The maximum velocity of the PDMS is observed at the center of the fluid flow, x/d=0.5. The shear rate was calculated as the velocity gradient (dVₓ/dx). The maximum shear occurs at the roller's wall and the higher R/d results in the higher shear rate.

Next, a parametric study is conducted for roller speed (U) of 30, 50, 80, and 100 rpm with R/d of 31.75, 36.29, 42.33, 50.8, and 63.5. The resulting dp/dx, \dot{γ}, and τ_{w} are plotted in FIGS. 3C-3E, respectively, at the roller speeds and roller distances. Each of these parameters increases with an increase in roller speed and R/d. The effect of R/d was more dramatic at higher roller speed. For example, the dp/dx increases only from 0.79 to 4.14 MPa m⁻¹ at 30 rpm but increases from 2.84 to 13.86 MPa m⁻¹ at 100 rpm. Similarly, at R/d of 31.75, the dp/dx increases from 0.79 to 2.84 MPa m⁻¹ as the roller speed increases from 30 to 100 rpm, respectively, whereas the same increase in speed causes dp/dx to escalate from 4.13 to 13.86, respectively. In summary, the CFD analysis established a method to determine some parameters that were not able to be examined in prior studies due to the limitation of the experimental tools. The dp/dx, \dot{γ}, and τ_{w} observed in the CFD simulation results can be utilized to analyze the experimental results in the following sections.

Ribbing instabilities in roll-coating of PDMS. Before diving into the ribbing phenomenon of the complex shear-thinning viscoelastic paste, a full-factorial experiment was conducted to investigate the ribbing of PDMS for various roller speeds and roller distances. The rheological properties of PDMS were found to be mostly Newtonian, as the viscosity change during steady shear was minimal. The roller's speed (U₁=U₂=U) was varied between 30 and 100 rpm, and the roller distance (d) was varied between 0.4-0.8 mm. Upon rotation of the rollers, a distinct ribbing phenomenon was observed. The ribbing wavelengths were defined by the distance between each riblet's peaks.

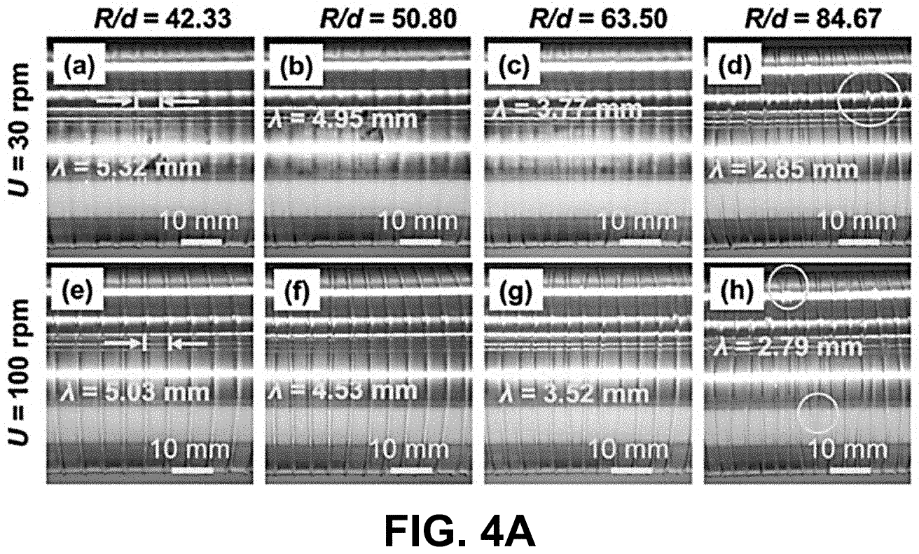

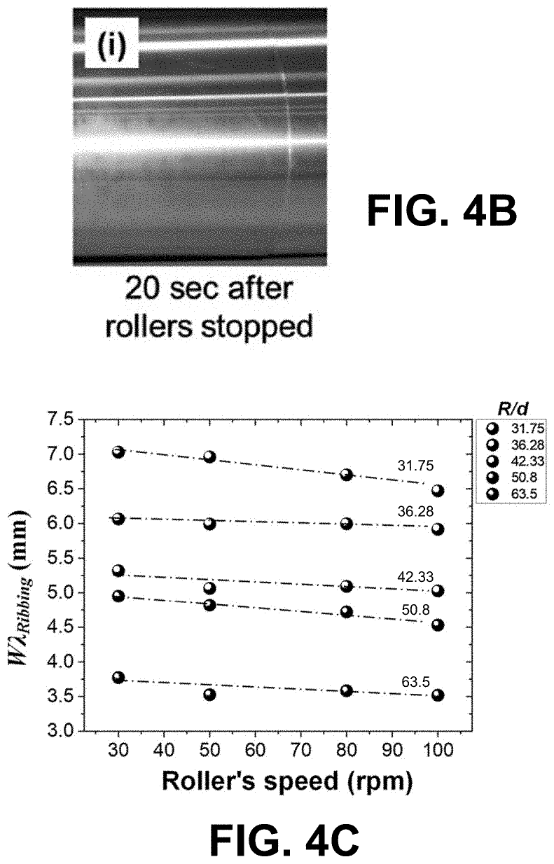

Upon rotation of the rollers, a distinct ribbing phenomenon is observed, identical to what was observed in the CFD simulation in FIG. 3A. The ribbing wavelength (λ_{ribbing}) is defined by the distance between each riblet's peak. Images (a)-(d) and (e)-(h) of FIG. 4A show the ribbing at roller speeds of 30 and 100 rpm, respectively. The ribbing wavelength (λ_{ribbing}) is investigated concerning the rollers speed (U) and the dimensionless geometric parameter R/d. For any given R/d, an increase in roller speed results in a decrease of λ_{ribbing}. A more dramatic reduction in wavelength is observed with the rise of R/d for any specific speed. For example, at R/d=31.75, the wavelength decreases from 7.03 to 6.47 mm with a 30-100 rpm roller speed increase. A decrease is also seen at R/d=42.33, 50.80, 63.50, and 84.67 (from 5.32 mm to 5.03 mm, from 4.95 mm to 4.53 mm, from 3.77 mm to 3.52 mm, and from 2.85 mm to 2.79 mm, respectively). At 30 rpm speed, the wavelength reduces from 7.03 to 3.52 mm as the R/d increases from 31.75 to 63.5, respectively. At a higher R/d (>63.5), the linear ribbing periodicity started to be nonuniform as can be seen in image (h) of FIG. 4A, similar to what was observed in the CFD simulation FIG. 3A. The ribbing pattern of the PDMS is only observed when the rollers are rotating. As soon as the rollers stop, the ribbing patterns flatten in a few seconds due to the surface tension. FIG. 4B is an image showing the PDMS flattening 20 seconds after stopping the rollers. As previously observed, the PDMS behaves like a fluid with nearly constant viscosity (about 5.2 Pa s) from a shear rate of 0.1 to 100 s⁻¹. This fluid-like behavior allows the surface tension force to flatten the ribbing patterns quickly.

FIG. 4C illustrates examples of the ribbing wavelengths of PDMS for various roller speeds and roller distance. It was also observed that at higher R/d (e.g., >63.5) the ribbing formation begins to be more unstable and random as can be seen in FIG. 4A. The surface energy (γ) of PDMS was measured (20.4 mJ/m²) was resulted in a capillary number (Cₐ=(V₁+V₂)×η/2μ) of 19 to 63 for the roller speed of 30 to 100 rpm. When the rollers stop shearing, the ribbing patterns disappear and begin to flatten as the surface tension dominates over the viscosity.

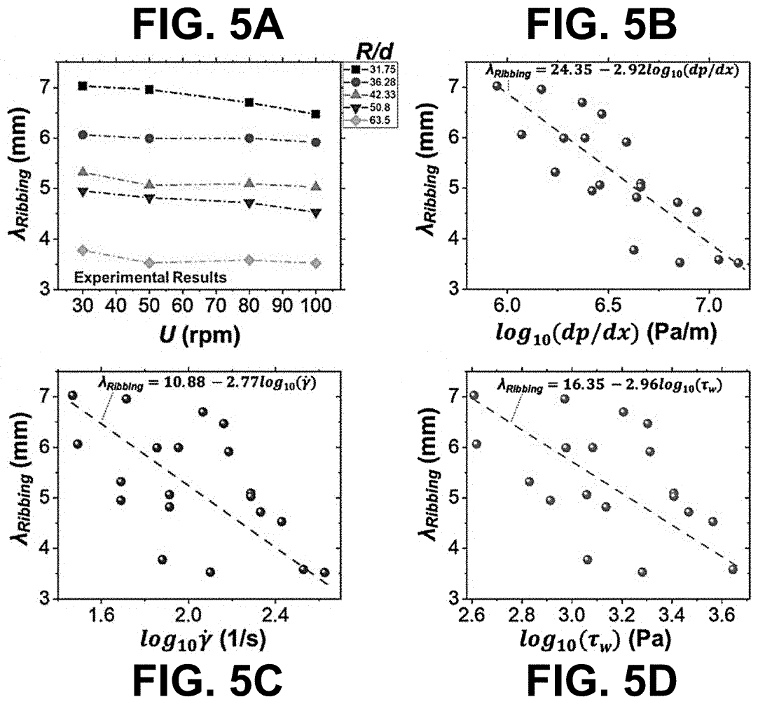

FIG. 5A illustrates examples of experimental data of PDMS ribbing wavelengths versus various process conditions. The calculated dp/dx, \dot{γ}, and τ_{w} from the CFD simulations are plotted against the experimental wavelengths. FIGS. 5B-5D show the experimental wavelengths of PDMS plotted against log₁₀(dp/dx), log₁₀(\dot{γ}), and log₁₀(T_{w}) calculated from the CFD analysis. The dp/dx was closely related to the ribbing wavelengths. A higher dp/dx associated with more instabilities resulted in shorter wavelengths. In addition higher \dot{γ} and τ_{w} also resulted in shorter ribbing wavelengths. A statistical analysis of the λ_{ribbing} individually with respect to log₁₀(dp/dx), log₁₀(\dot{γ}), and log₁₀(T_{w}) shows a correlation factor of −0.836, −0.81, and −0.823, respectively, proving a strong relationship between these parameters. In addition, a linear fitting between these parameters also shows R-square values of 0.68, 0.64, and 0.66 consecutively for the equations shown in FIGS. 5B-5D. A lack of fitting analysis for the linear fitting results in a p-value of 0.056, 0.243, and 0.25. This demonstrates that the fittings are significant with 95% confidence (p-value >0.05).

In summary, two findings are apparent from the roll-coating of the PDMS. It was observed that the wavelength decreases with an increase in roller speed or R/d, wherein the effect of R/d was most significant with the rise of R/d. The dp/dx, \dot{γ}, and τ_{w} drive the wavelength formation. The PDMS cannot retain the ribbing patterns when the rollers stop as the materials behave as a fluid. This draws interest in synthesizing coating materials that will behave as a solid when at rest, preventing surface tension-driven flattening, but acts as fluid during the roll-coating allowing the ribbing formation to occur. A significantly higher Cₐis needed for shape-retention of the ribbing structure when the rollers come to a stop. Nanoparticles (e.g., carbon nanotubes or CNTs) were introduced into the PDMS to tailor the viscoelastic properties of the coating materials to achieve a suitable Cₐ. However, a higher Cₐ also incurs higher instabilities. By careful experimentation with various CNT wt % with the PDMS, 3.5 wt % CNT-PDMS composites were found to be the most suitable composite as this successfully retained the shape, as well as the instabilities, in a controllable order.

Ribbing Instabilities in Roll-Coating of CNT-PDMS Composite. The CNTs were next introduced into the PDMS to tailor the viscoelastic properties of the coating materials. A yielding material is needed to avoid surface flattening when the rollers stop, which will selectively behave like a fluid in elevated shear stress but behave as a solid when the stress is unloaded. The entanglement of the cylindrical-shaped CNTs allowed such behavior. Composite paste with various concentrations of the CNTs was synthesized and utilized in the roll-coating process. At first, 0.5 and 1 wt % CNT were added to the PDMS matrix, and the roll-coating was observed in a high-speed camera.

Similar to the PDMS, ribbing formation is observed for 0.5 wt % CNT-PDMS composite. However, another phenomenon known as filamentation was also observed during the roll-coating. A small hole appears, generating a filament at the roller's interface. As the roller rotates, the hole becomes more prominent as the filament stretches, eventually breaking and developing a peak on top of the ribs. The produced surface is thus a hybrid of ribbing formation and peaks from filamentation rupture. The elastic relaxation of the composite paste has a important effect in generating such micropeaks, with lower elastic materials expected to have shorter peaks. The extensional viscoelasticity of the composite paste and how it influences the instabilities in roll-coating can also be considered.

The roll-coating with 1 wt % of CNT-PDMS with roller speeds of 20, 60, and 100 rpm and R/d of 50.8, 63.5, and 84.67 were examined. The observed hybrid pattern is similar to 0.5 wt % CNT-PDMS results. At 20 rpm speed, the wavelength reduces from 1.03 to 0.49 mm with an R/d increment from 50.8 to 84.67. Notice that the ribbing wavelengths in PDMS ranged from 2.8 to 5.32 mm, whereas the wavelength significantly reduced with the addition of CNTs. This may be attributed to the higher viscosity of the coating paste, causing more dramatic dp/dx resulting in a shorter wavelength. In addition, the linearity of the wavelength formation is also compromised at higher speed and R/d.

The roll coating of 0.5 and 1 wt % CNT-PDMS provided important understanding. i) The wavelength reduced significantly compared to the PDMS as the viscosity and elasticity increased. ii) An additional mode for pattern formation known as filamentation was also observed, which affects the final patterns. iii) At a lower velocity, it was observed that the patterns were more likely to align linearly. iv) In addition, the wavelength control was more precise by controlling the R/d, which is also observed in the roll coating of the PDMS. These findings guided subsequent experimentation with higher wt % CNTs for potentially reducing ribbing wavelength in the micrometer range.

Coating pastes were prepared by adding various wt % of CNTs to the PDMS. 3-3.5 wt % CNT-PDMS provided the most linearly periodic samples upon extensive experimentation. As the wt % of CNTs increases, the higher viscosity and elasticity cause the generated pattern to be more random. For example, no forms of linearity were observed in roll-coating samples with >5 wt % CNTs. The 3 wt % CNT-PDMS sample showed ribbing instabilities and produced a microtrench profile at R/d of 63.5 at 50 rpm roller speed. However, an attempt to further reduce the ribbing wavelength by increasing the R/d resulted in a linear to vein-leaf shape transition at R/d=84.67. A further increase in R/d to 101.6 results in vein-leaf shape samples with a high aspect ratio with a large ribbing wavelength at a millimeter scale. Thus, a more viscous material, 3.5 wt % CNT-PDMS, was utilized to prepare the final samples and further reduce the microstructured surface's wavelength. The roller's speed was fixed at 20 rpm, while the R/d varied from 56.44 to 127.

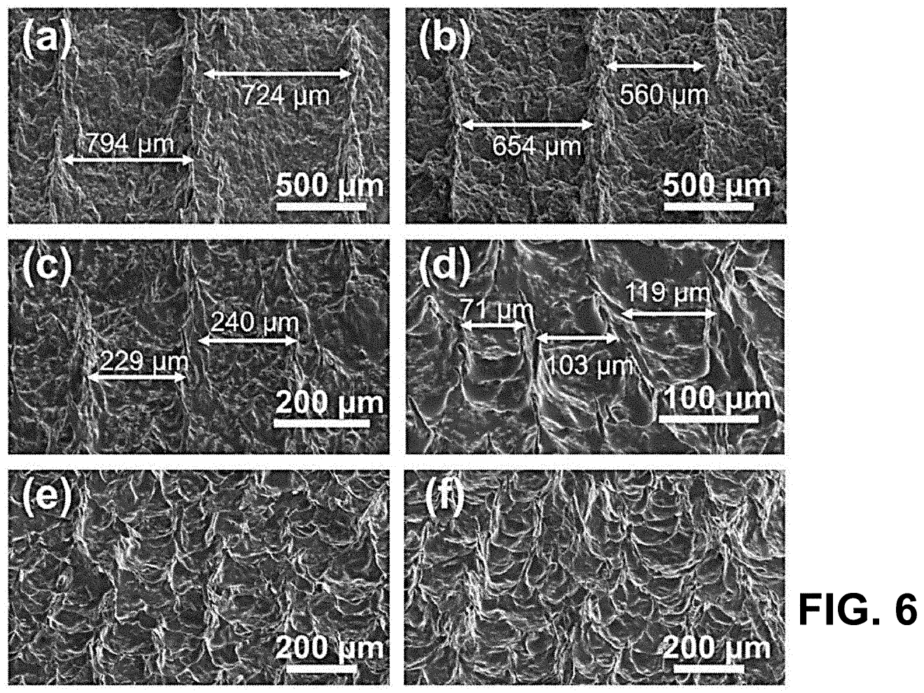

Surface Morphology Analysis. The 3.5 wt % CNT-PDMS samples showed a hybrid microstructure created by ribbing and filamentation similar to 0.5 and 1 wt % CNT-PDMS. While the ribbing waves were observed transverse to the roll-coating direction, filamentation resulted in many micropeaks in the longitudinal direction. The SEM images of the samples are shown in FIG. 6. The SEM images were at 20 rpm with R/d=(a) 56.44, (b) 63.50, (c) 72.57, (d) 84.67, (e) 101.60, and (f) 127. The R/d=56.44, 63.50, 72.57, and 84.67 showed mostly linear ribbing formation, whereas the R/d=101.60 transitioned to a more random microstructure. Despite less consistent microtrenches in comparison to 3 wt % CNT-PDMS samples, it was possible to achieve shorter λ_{ribbing}. The randomness increased to taller features at R/d of 127. The ribbing wavelengths were reduced from 700 to 90 μm for the linear-microstructure sample in images (a)-(d). The images for R/d=101 and 127 samples showed highly dense micropeaks and a high aspect ratio. The entangled CNTs with their yield stress allowed the PDMS to retain the complex microstructure after roll-coating by resisting the surface tension-driven flattening.

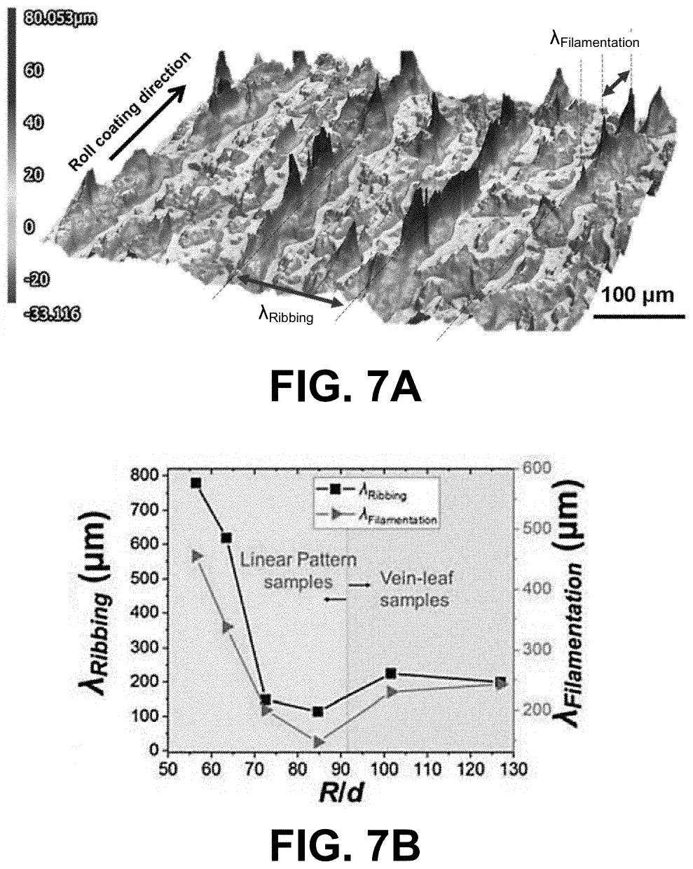

Since the SEM shows only a small area of the samples, a laser confocal microscope was utilized to quantify the wavelengths and surface roughness. FIG. 7A shows an example of a sample 3D topography. The ribbing wavelength (λ_{ribbing}) is defined as the distance between each transverse riblet. The filamentation wavelength (λ_{Filamentation}) is the peak-to-peak distance in the longitudinal direction, as shown in FIG. 7A. The samples included random microstructures along with linearly periodic patterns. To quantify the wavelengths, multiple (>20) transverse and longitudinal lines (were drawn on the 3D surface with the Multifile-analyzer software (e.g., Keyence). Each of these lines showed the peaks and valleys of the surface topography. The wavelengths for these individual lines were evaluated by the software, and plotted in FIG. 7B (λ_{ribbing} and λ_{Filamentation} versus R/d). The wavelengths reduce for both ribbing and filamentation phenomenon with an increase in R/d, associated with more instabilities. The average λ_{ribbing} was 777, 618, 148, and 114 μm for the R/d=56.44, 63.50, 72.57, and 84.67 samples. However, when the linear microstructure transitions to a random microstructure at R/d=101.60, the wavelength increases to 224 μm. The average λ_{Filamentation} also follows the same pattern as the observed wavelengths were 455, 337, 200, 146, 230, and 242.98 μm for the R/d=56.44, 63.50, 72.57, 84.67, 101.60, and 127. The Wenzel roughness factor (r) was also evaluated, which is discussed in conjunction with the water contact angle measurement result.

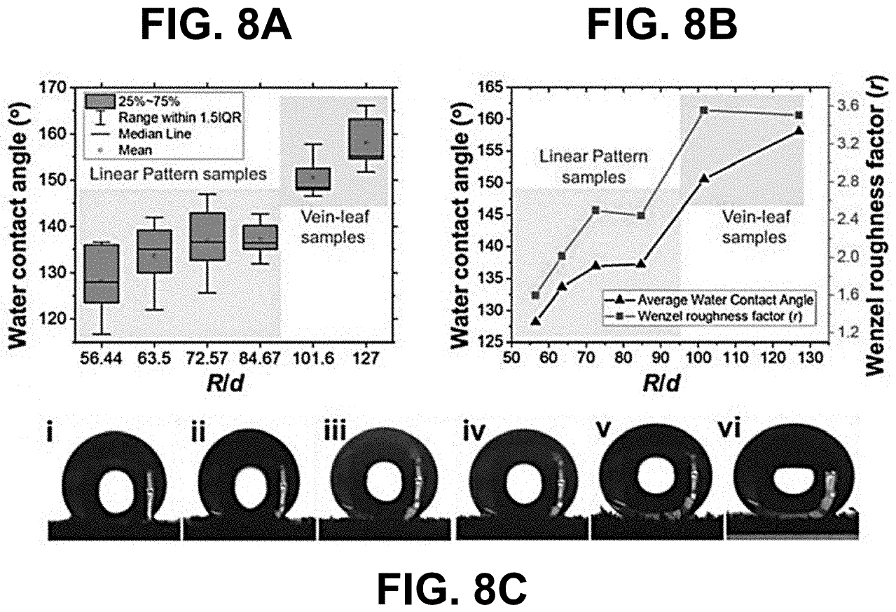

The water contact angles (WCA) of the microstructured samples were measured to demonstrate the hydrophobicity of the surface. FIG. 8A shows the water contact angle measures boxplot and FIG. 8B shows average water contact angle and Wenzel roughness factor versus R/d. The measurement was done in five different locations for each of the samples. The average WCA of the linear microstructured samples were 128.17°, 133.64°, 136.98°, and 137.27° for R/d=56.44, 63.5, 72.57, and 84.67, respectively. In comparison, a compression-molded flat CNT-PDMS sample showed a WCA of 115.4°. Thus, the increased WCA to R/d is related to the roughness of the fabricated sample. However, the trend stalls right before transitioning from a linearly periodic microstructure to a high aspect ratio random microstructure. The WCA dramatically increases into the superhydrophobic range to 150.63° and 158.13° for R/d=101.6 and 127. This is primarily due to the increase in the surface area of the samples due to enhanced hierarchical structure geometry, which is also reflected in the high Wenzel roughness factor of about 3.5. The WCA and the Wenzel roughness factors matched well as shown in FIG. 8B. The water droplets images for the highest observed WCA obtained for the R/d ration of (i) 56.44, (ii) 63.5, (iii) 72.57, (iv) 84.67, (v) 101.6, and (vi) 127 are shown in FIG. 8C.

The roll-coated samples were broadly classified into two categories based on the microstructures. The generated patterns were mostly linearly periodic in samples for the 3.5 wt % CNT-PDMS samples with 20 rpm speed and R/d 84.67 as shown in FIG. 6. Whereas samples with R/d=101.6 and 127 showed more vein-leaf shape structure with high aspect ratios. The results indicate a significant alteration in the ribbing formation after the R/d value of 84.67. However, since the roll-coating experiment itself could not provide further information on the state of the coating paste, such as the fluid velocity, pressure gradient, shear rate, and wall shear stress, further CFD analysis was conducted to evaluate these parameters and potentially correlate with the experimental results observed by the SEM and laser confocal.

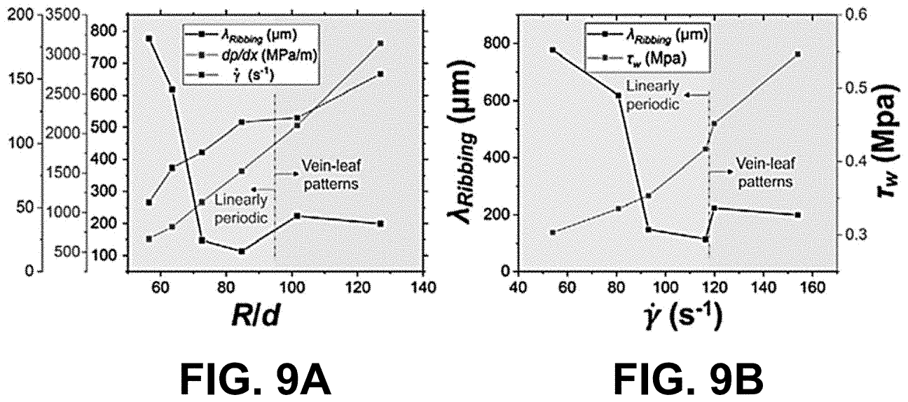

The pressure gradient in the direction of fluid flow, dp/dx for 3.5 wt % CNT-PDMS, was observed to be an order of magnitude higher than PDMS. FIGS. 9A and 9B illustrate CFD simulation results of (a) λ_{ribbing}, dp/dx, and t versus R/d and (b) λ_{ribbing} and wall shear stress versus shear rate for roll-coating of 3.5 wt % CNT-PDMS under various process conditions. The dp/dx ranged from 667 to 3138 MPa m⁻¹ for R/d of 56.4 to 127 as seen in FIG. 9A. The enormous increase in pressure gradient is sourced from the elastic nature of the viscoelastic fluid, which restricts the flow and increases the stress significantly. The high dp/dx results in much more aggressive ribbing instability even at a slower roller speed than PDMS.

The associated shear rate during the roll-coating experiments was also evaluated based on the CFD analysis. The roll coating of 3.5 wt % CNT-PDMS at 20 rpm speed results in 54.02, 80.81, 93.04, 116.37, 119.87, and 154 s⁻¹ shear rate for R/d of 56.44, 63.5, 72.57, 84.67, 101.6, and 127. Notice that the wall shear stress steadily increases from 0.3 to 0.41 MPa for R/d of 56.44 to 84.67. However, at R/d 101.6, when the shear rate is 119.87 s⁻¹ the wall shear stress increases sharply to 0.45 MPa as shown in FIG. 9B. The abrupt change in wall shear stress results in further tip-splitting, which results in the vein-leaf shape structure. Similar tip-splitting behavior has been observed specifically for elastic materials and an increased elasticity dramatically changes the shape structure to be more random. The CFD analysis of the roll coating of 3.5 wt % CNT-PDMS helped to uncover the roll coating process parameter along with the associated dp/dx, \dot{γ}, and τ_{w} that contribute for the transitions between the linear to vein-leaf shape formation.

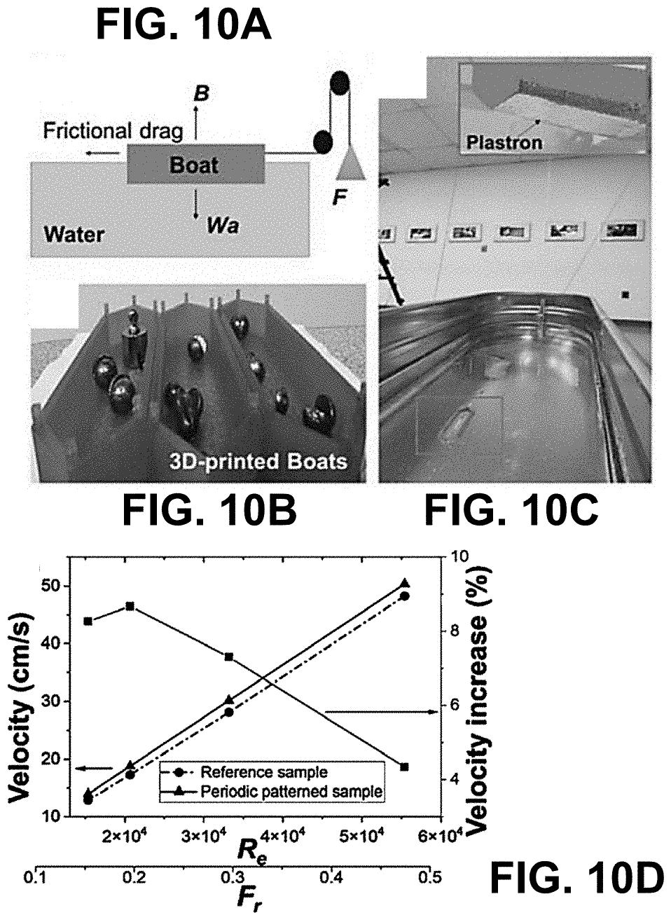

Hydrodynamic Drag Reduction. The hydrodynamic drag reduction of the linear microstructured sample was measured by attaching the sample to the underside of a miniature boat and pulling it parallel to the water surface using a wire-and-pulley system. FIG. 10A is a free-body diagram of the drag-reduction experimental setup and FIGS. 10B and 10C are images of the miniature model boats with standard loads and in the testing setup. A weight was used to create a steady tension in the wire that pulls the boat with a constant force. Four different loads (e.g., 1.7, 0.8, 0.6, and 0.5 g) were used for the boat to reach four different steady speeds. The time it took for the boats to travel a set distance (180 cm) was measured, and the acceleration time was short enough to be ignored. The velocity, acceleration, Reynolds number (Re), and Froude number (Fr) of the boat and the velocity increase of the boats with the linear microstructured sample relative to the ones without were calculated from the measured times. FIG. 10D shows the velocity profile of the model boat with and without the linear microstructured sample. For Reynolds numbers 55 397, 33 163, 20 677, and 15 348, the velocity increases (or drag reductions) were 8.27%, 8.68%, 7.31%, and 4.34%, respectively.

This decrease of drag reduction with increasing Reynolds number, which deviates from what is known for laminar flows, can be explained by the large Froude number even at low Reynolds numbers due to the small boat size. Note that the boat's drag in the current experiment comprises skin friction and wave-making, and the given sample can reduce only the skin-friction drag with no effect on the wave-making drag. When Fr<0.25, the skin friction drag is dominant; however, the wave-making resistance dominates when Fr>0.25. When the Froude number increased (0.13, 0.18, 0.29, and 0.48, correspondingly) so that the portion of skin friction in the total drag decreased, the reduction of skin friction had a diminishing effect on the total drag. The sample with the densest linear patterns (R/d=84.67, λ_{ribbing}=114 μm) was the most significant drag-reduction reported in this section. The samples with broader wavelengths did not have a conclusive result as they lack the ability to retain the plastorn.

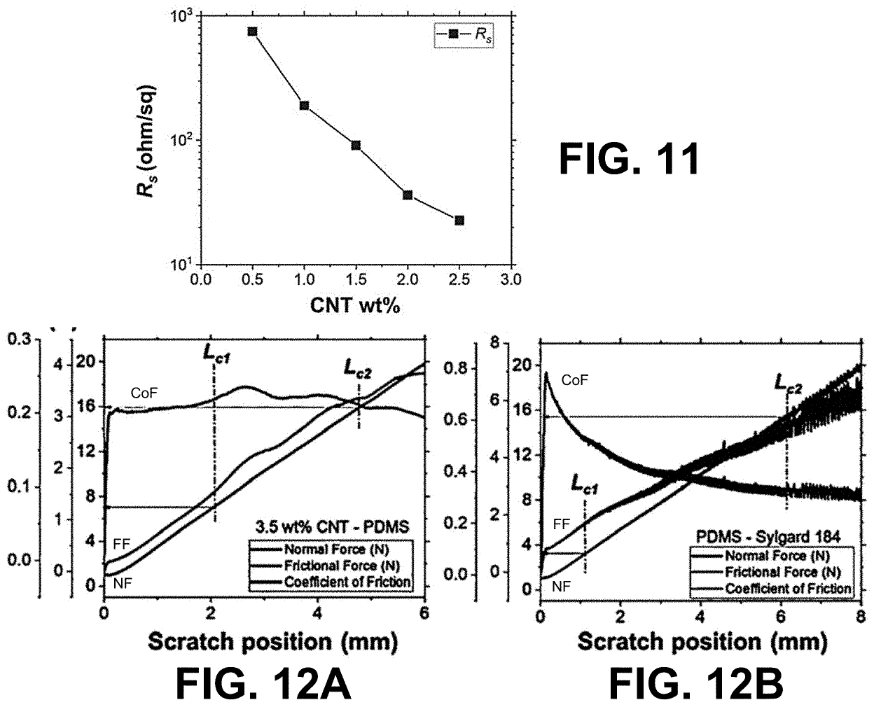

Electrical Conductivity Measurements. Adding a conductive filler in a nonconductive polymer matrix was found to incur electrical conductivity based on prior studies. Such reinforcement by mechanical-mixing procedure was also observed to improve the electrical and mechanical properties simultaneously. Since CNTs are highly conductive, there is a potentiality of achieving multifunctionality of the SHPo samples if electrical conductivity is also observed. The electrical sheet resistance of the CNT-PDMS composite samples was measured by a custom-made four-point setup following the Van der Paw method with varying CNT wt % and is represented in FIG. 11. It was found that CNT wt % of 0.5, 1.0, 1.5, 2.0, and 2.5 had sheet resistance values of 747.84, 190.36, 90.64, 36.26, and 22.66 Ω□⁻¹, respectively. The decrease in sheet resistance because of increased CNTs creates a percolated network. The CNTs form a percolated network in PDMS which is attributed to the enhanced electrical conductivity. As more CNTs are added, the percolation increases until reaching a certain percolation threshold.

In a percolated network, electrons move across the network under an applied electrical field, which increases electrical conductivity. This increase in electrical conductivity, therefore, decreases the measured sheet resistance. Thus, as more CNTs are added, the percolated network grows and enables a decrease in the sheet resistance by increasing electrical conductivity. The PDMS-Sylgard 184 sample resistance was undetermined in the experiment, possibly due to very high resistivity.

This is also important to mention that manufacturing SHPo surfaces capable of plastron regeneration has been carried out by attaching additional conductive electrodes integrated into the surface, which allowed plastron regeneration by electrolysis when the water began to penetrate the microtrench cavities. However, the fabricated microtrench structure would also be able to regenerate plastrons without additional electrode molding since the CNT-PDMS material is reasonably conductive. The plastron regeneration capabilities of the manufactured SHPo surface may be determined.

Scratch Testing. The robustness of the 3.5 wt % CNT-PDMS microstructured sample was tested to identify the load of cohesive and adhesive failure. This load is the smallest load that causes microstructural damage for possible cracking or plastic deformation. Although this test is not a comprehensive materials property test as the test parameters also have an effect, the load observed in such a scratch test is also a function of the mechanical strength of the materials. The first mode of failure, or the cohesive failure (L_{C1}) in the CNT-PDMS sample, was observed for 7 N force as there seemed to be a sudden increase in the frictional force. FIGS. 12A and 12B illustrate the scratch test of 3.5 wt % CNT-PDMS composite and PDMS-Sylgard 184 samples, respectively. The secondary failure was observed at 16 N, the adhesive failure between the test sample and the substrate. The frictional coefficient for the 3.5 wt % CNT-PDMS composite was stable at about 0.2. Compared to the CNT-PDMS sample, the PDMS sample's cohesive failure occurred at a lower force of 3.6 N. The adhesive failure (L_{C2}) was similar to the CNT-PDMS sample of 15.8 N force. The frictional coefficient of the PDMS sample seems to be much higher (about 0.35-0.45) than the CNT-PDMS sample. The microstructured surface assisted in this reduction in tribological friction. The CNT addition helped the composite layer achieve superior mechanical properties compared to pure PDMS. As observed, the entangled CNTs physically interlock the PDMS from slippage and improve the mechanical properties. The wear properties of the CNT-PDMS microstructures layer and underwater testing can determine possible material degradation.

A comprehensive investigation was conducted to study the ribbing formation during a roll-coating process both computationally and experimentally. First, ribbing instabilities for the pure PDMS were investigated. It was found that the pressure gradient occurring due to roller speed, R/d, and the material's viscoelastic properties is the driving force of the ribbing instabilities. The wavelengths for the PDMS were observed in the 7.03-3.52 mm range for roller speeds from 30 to 100 rpm and R/d of 31.75 to 63.50. The ribbing formation of PDMS was also observed to flatten when the roller stops due to lower surface energy compared to the viscosity and also not having yield stress. Increasing the CNT content on the PDMS allows the polymer to retain its solid shape even after stopped roll-coating as yield stress of 0.0025, 0.01247, and 0.08737 MPa was observed for 1, 3.5, and 10 wt % of CNT-PDMS. The observed microstructure of the surfaces by the roll-coating was characterized as a hybrid pattern due to ribbing instability and filamentation due to elastic relaxation of the coating paste.

The manufactured samples showed a controllable 114-777 μm size. However, as the roller distance decreases further to increase the R/d to 101.60, the linear ribbing transitions into the random microstructure with a high Wenzel roughness factor (r) of 3.56. The water contact angle of the samples ranged from 128.17° to 158.63°. The CNTs addition also made the samples conductive, opening opportunities for multifunctional applications. The mechanical durability of the fabricated microstructures is also investigated by scratch testing. Finally, the fabricated pieces demonstrate drag reduction capabilities in miniature model ships, self-cleaning surfaces, and anti-biofouling applications.

A simple, scalable fabrication process has been demonstrated to achieve periodic microstructures. Suitable material composition and process parameters have been identified to control the microtrenches' periodicity. However, the periodicity and uniformity in the produced samples are not close to the photolithography-based manufactured samples. The technique has enormous potential for scalable manufacturing. The complete sample preparation needed only half an hour, beginning with the coating paste preparation, roll-coating, and heat-curing. The maximum size achievable with the presented two-roll-coater was 300 mm×150 mm, only constrained by the diameter and length of the rollers. Taking advantage of the ribbing instabilities, a large periodic microstructured surface can be obtained quickly by employing a more robust roll-coater with continuous substrate-feeding capabilities. The process parameters can be fine-tuned, including materials that may improve the control of the surface morphology to move closer to the photolithography-based techniques.

Passive Radiative Cooling of Photovoltaics

With the global temperature on the rise, renewable energy has become increasingly popular. Solar energy consumption saw a 27% increase per year at the start of the 21st century largely due to increasing solar panel installation in residential applications. In 2020, solar photovoltaic energy accounted for over 115,000 GWh of energy being produced in the United States, with significant additions around the world as well. With this increase in solar energy, it is important that solar panels function at the highest possible efficiency. Both dust and increased temperatures are detrimental to the efficiency of photovoltaic panels. As such, it is necessary to develop mitigation for these hazards.

Most silicon-based photovoltaic cells generate power using visible light and near-infrared (IR) (0.4-1.1 μm). All other wavelengths are absorbed by the panel as heat. Electrical losses also contribute to the heating of solar cells. Solar panel efficiency is inversely proportional to the temperature of the photovoltaic cell. It is known that a 1° C. increase in temperature can lower the efficiency of a solar cell by 0.4-0.5%. Furthermore, prolonged exposure to increased temperature can decrease the lifespan of photovoltaic panels. Therefore, maintaining a low operational temperature is important to optimize the function of solar cells.

Most previous methods of cooling photovoltaics involve increasing the convective heat transfer between the solar cell and the surrounding air. This has been demonstrated using both water and air as heat transport mechanisms. These methods act by transferring heat from the solar cell to a transport medium and dissipating excess via a heat exchanger. While these methods were proven to be effective, they require additional hardware to be added to the solar cell making them more expensive, bulky, and less efficient for industrial applications.

To mitigate the need for extra hardware, recent research has shifted to the use of passive radiative cooling films. These films cool the underlying surface by reflecting much of the incoming light as well as promoting increased IR emission which is radiated back into space through the atmospheric window (8-13 μm).

Recent studies have shown that passive cooling using nanoparticle composites and photonic structures can be effective for cooling solar panels. Transparent passive cooling films have been demonstrated as being capable of cooling the underlying surface by up to 14.95° C. These cooling films can be created by dispersing ZnO nanoparticles in a low-density polyethelene matrix. A nanocomposite film using SiO₂ particles embedded in a polymethyl methacrylate matrix have been developed that can cool the underlying surface 4-5° C. below ambient temperature using a compression molding process. Precise process control is needed in to apply appropriate amounts of pressure to avoid substrate damage. Precise molding temperature, molding pressure, and holding time are important variables in the compression molding process, which can impact polymer performance. A transparent radiative cooling layer composed of SiO₂ gratings on an Si wafer simulating the Si-based photovoltaics have been fabricated using the UV photolithography process. Both photolithography and compression molding are time and material intensive. Furthermore, these manufacturing methods tend to be costly and are not scalable.

In this disclosure, novel manufacturing methods are presented for the creation of photonic passive cooling surfaces using a roll coating process, which has manufacturing advantages in terms of cost as well as scalability, are developed. In this process, as viscous material passes through the gap between two rollers, a positive pressure gradient is made in the coating meniscus downstream. The pressure gradient, along with shearing stress applied by the coating roller, causes instabilities and defects to form. This instability, when a certain value is reached, causes linear patterns, ribboning, or spiked defects to appear on the surface. The manufacturing parameters which influence what type of surface is generated include the roller gap, which influences the pressure gradient, and the roller speed, which influences the shear rate. High shear rates coupled with a small roller gap will create higher density randomly spiked patterns.

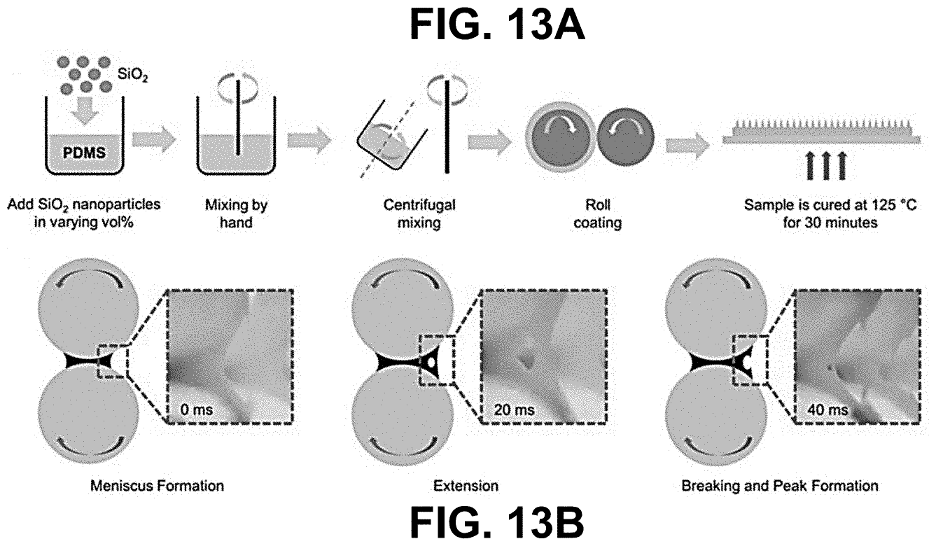

Referring to FIG. 13A, shown is an example of a manufacturing process for creating SiO₂/PDMS films. Nanoparticles can be added in varying volume percentages and then mixed by hand and/or using centrifugal mixing. The mixture can then be roll coated. Different surface textures are created by varying roller distance and speed. Samples can be cured for 30 minutes at 125° C. FIG. 13B illustrates the process of forming the surface texture using roll coating. A meniscus is formed due to pressure gradients in the fluid. This meniscus can then be stretched and broken to form peaks and ridges. This process occurs continuously along the roller and occurs in, e.g., about 40 ms.

Similar interfacial behavior is often observed in the texture of walls painted by the roll-brush. Typically, these defects disappear after being extruded through the roller gap because the material's surface tension causes the defects to flatten over time. This property of viscous materials can be manipulated by adding nanoparticles to modify the materials rheological properties. The addition of nanoparticles can also carry secondary effects such as increasing the materials IR emittance or solar reflectance. With added nanoparticles, the viscosity and yield strength dominate over the surface tension. The size and spacing of the defect peaks were demonstrated to have a correlation with material properties (such as surface energy and viscosity) along with manufacturing parameters (e.g., roller radius, roller gap, and roller speed). By adding varying fractions of nanoparticles and changing manufacturing parameters, the topology of fabricated films can be manipulated to desired constraints.

In this example, SiO₂/Polydimethylsiloxane (PDMS) nanocomposite films were developed using roll coating methods for use in passive cooling of solar cells. These films were designed to have rough surface textures to promote increased radiation emittance and anti-fouling properties. The composite films were designed with two optical criteria in mind: visible transparency, and high mid-IR emission. Furthermore, the films were designed to have very rough surface textures in order to promote increased emission as well as create possible anti-fouling properties.

Ultraviolet-Visible (Uv-Vis) and FTIR spectroscopy were performed in order to characterize the optical properties of the material. The surface roughness was characterized by laser confocal microscopy and measurement of the water contact angle (WCA). Images of the water contact angle were measured by a goniometer. The images were then processed using an open-source software named ImageJ. Finally, the films performance on solar cells was characterized by outdoor solar panel tests.

Materials. To create the films, an appropriate amount of Sylgard 186 silicone elastomer (purchased from Krayden, Inc) was measured. Varying volume percentages of SiO₂ nanoparticles were then added into the mixture. The SiO₂ nanoparticles are spherical in shape with average diameter 20-30 nm purchased from US-nano, Inc. Hardener was added to this mixture in a 10:1 ratio of PDMS/hardener. This mixture was initially stirred by hand. Once a uniform paste had been formed, it was placed in a centrifugal mixer for 10 minutes before being roll coated.

Polydimethylsiloxane (PDMS) was chosen as the substrate due to its high IR emission. Fourier-Transform infrared (FTIR) spectroscopy reveals peaks at 3000 nm as well as a series of peaks between 6000-20000 nm range. SiO₂ nanoparticles were chosen to modify the viscosity of PDMS because they have high IR emission while maintaining visible transparency. SiO₂ particles are able to enhance the mid-IR emission due to the absorption peak at 9 μm. Phonon polarization resonance is another characteristic of uniformly distributed SiO₂ nanoparticles, which contributes to their thermal emissivity. Furthermore, since appropriate transparency in the solar spectrum is an important requirement for any solar panel cooling film, SiO₂ nanoparticles were chosen because they closely match the refractive index of PDMS (n_{PDMS}=1.43, n_{SiO2}=1.45).

Roll Coating Process. Eight different SiO₂/PDMS films were manufactured for this experiment: Four flat and four rough films with 4, 6, 8 and 10 volume percent of SiO₂ (10, 14, 18, 21 weight percent). The machine used to fabricate the samples had 2 rollers each with radius 25.4 mm and 300 mm in length. The speed, direction, and distance of each roller was able to be individually controlled. One roller was coated in a layer of Kapton tape which allowed the samples to be easily removed from the roller after the roll coating process was complete. Initially, both rollers were kept at rest and the SiO₂/PDMS paste was spread on the rollers. The speed of each roller was then simultaneously increased. All samples tested in this report were fabricated using a roller distance of 0.1 mm and a roller speed of 100 rpm.

To manufacture films with a flat surface, the paste of nanoparticles and PDMS was spread on the rollers. The speed of one roller was then slowly increased to 100 rpm while the other roller was kept stationary. This caused the paste to be spread over the moving roller in an even film. To manufacture the rough films, the PDMS was spread on the rollers as before. Next, the speed of both rollers were simultaneously increased to 100 rpm. After removing the Kapton Tape from the rollers, the films were cured in an oven at 125° C. for 30 minutes. This process is illustrated in FIG. 13A.

Surface Topography Characterization. The surface topography of the rough samples was characterized by a non-contacting laser scanning confocal microscope (Keyence VK-X1100, 0.5 nm height resolution, and 1 nm width resolution). The peak height and density were then evaluated from this data.

The water contact angle of each film was measured by a Ram'e-hart goniometer (model 250, with the charge-coupled device camera and a 150 W fiber optic illuminator accessories) at ambient temperature of 23° C. For each sample, 2 μL of water were dropped on the surface. Images were captured at three different locations on each sample. Finally, the water contact angle of each image was found using the drop analysis plugin for ImageJ software.

Optical Properties Characterization. The reflectance of each film was measured by Uv-Visible spectroscopy spectrometer (UV-Vis, 300-2000 nm, Agilent technologies, Cary 6000i) using a calibrated BaSO₄ integrating sphere and a BaSO₄ reference at 0.3-1.8 μm. Emittance was measured by a Fourier Transform Infrared spectrometer (FTIR, 4-18 μm, Thermo Scientific, iS50) using a diffuse gold integrating sphere.

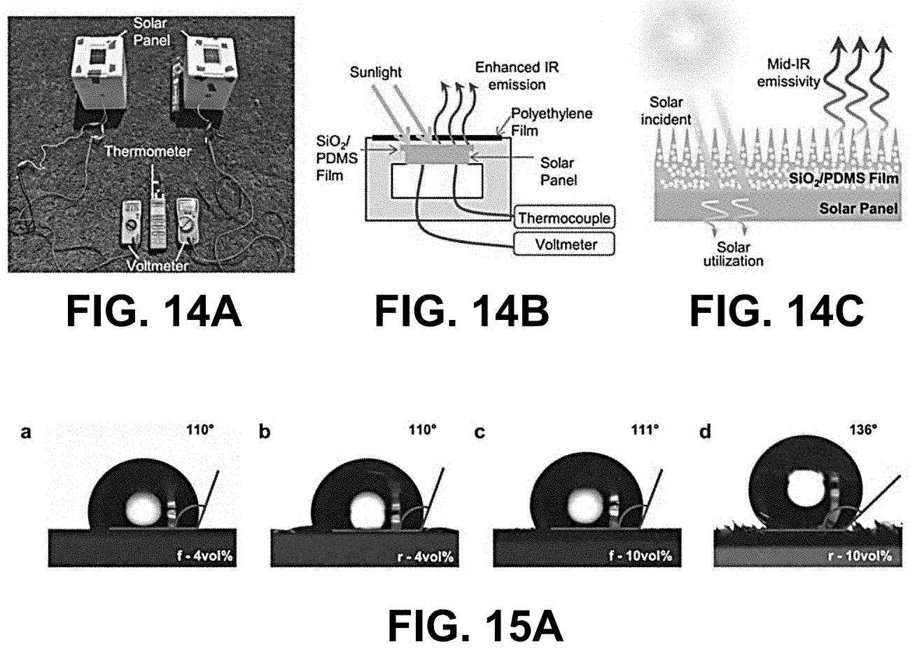

Solar Panel Testing. Outdoor tests were performed to test the passive cooling ability of the films as well as evaluate their impact on the power generation of the solar cells. An image of the test setup and a graphical description of the experimental setup is shown in FIGS. 14A-14C. As shown in FIG. 14A, a silicon based solar cell was placed in a hole or slot within the lid of a polystyrene container. The purpose of this container was to shield the solar cell from any heat transfer from the environment. The SiO₂/PDMS film was coated on the solar cell by peeling it from the Kapton tape and laying it over the top surface of the solar cell. No additional adhesives were used to secure the film in place. As shown in FIG. 14B, the solar cell and film was then covered with the polyethylene film to ensure that there was no convective heat transfer between the solar panel and the environment. The film allows visible light to pass through and be utilized by the solar cell beneath while increasing the Mid-IR emissivity as illustrated in FIG. 14C.

A thermocouple was attached to the back of the solar cell. The voltage output of the solar cell was measured using a voltmeter. Measurements of temperature and voltage were taken every 10 minutes for 3 hours. The outdoor experiments were performed in Raleigh, North Carolina. Three solar cells were tested at a time. The first solar cell had no film applied to it in order to act as a control sample. The next two cells had the flat and rough SiO₂/PDMS films applied respectively. This allowed for the different volume percents to be compared to a control sample.

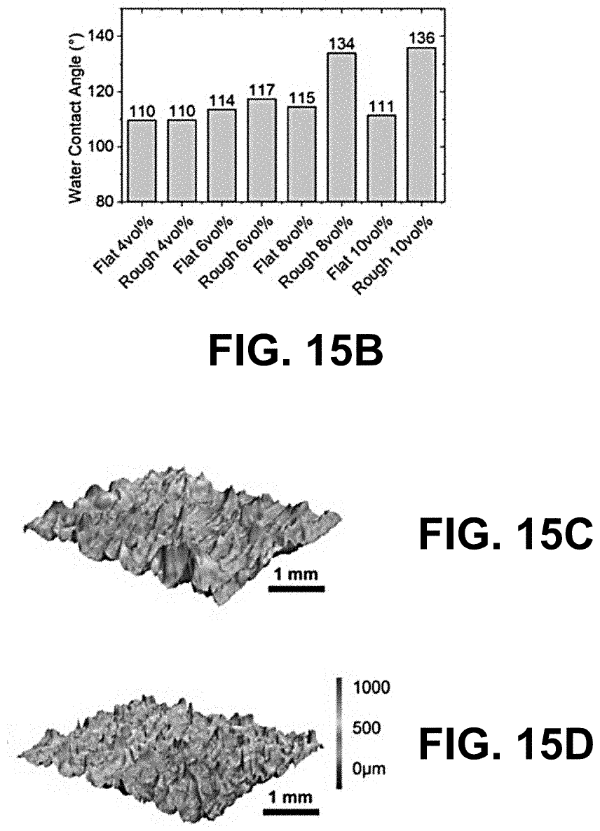

Surface Characterization—Water Contact Angle. The water contact angle was measured for each sample. FIG. 15A shows (a) WCA for the flat 4 vol % sample, (b) WCA for the rough 4 vol % sample, (c) WCA for the flat 10 vol % sample, and (d) WCA for the rough 10 vol % sample. The averages are shown for the different samples in FIG. 15B. Surface texture began to have an impact on water contact angle for high volume percents. At low volume percents, there was very little difference between the flat and rough samples. However, for the 8 and 10 percent samples there was an approximately 20° difference in water contact angle between the flat and rough samples. This difference can be seen in FIG. 15B. The difference between high and low volume percent samples is due to the difference in the viscosity of the mixtures. The 4 and 6 volume percent samples were much less viscous than the higher volume percents. As a result, the lower volume percent samples did not hold their shape well and began to flatten as soon as they were removed from the roller.

Surfaces with high water contact angles tend to show antifouling merits due to the fact that the surface texture makes it harder for large dust particles to settle on the surface and easier for water to wash away contaminants. The 4 and 6 volume percent samples showed no significant variation in WCA between the flat and rough samples and had poorly defined surface topography in comparison to the 8 and 10 volume percent samples. Due to these poor results, the 4 and 6 volume percent samples were excluded from further experiments.

Surface Characterization—Laser Confocal. Laser confocal microscopy was performed to characterize the surface topology of the 8 and 10 volume percent rough samples and is shown in FIGS. 15C and 15D respectively. Both the 8 and 10 percent samples have very dense peaks with spacing between 400-500 μm. The peaks on the 8 percent sample are slightly higher (with a peak height of 700 μm) than the 10 percent samples (with a peak height of 600 μm). However, the shape of the peaks on the 10 percent film is much sharper. These sharper peaks tend to lead to surfaces with higher water contact angles. Overall, it was seen that the higher volume percent samples were more viscous and led to the formation of sharper less rounded peaks.

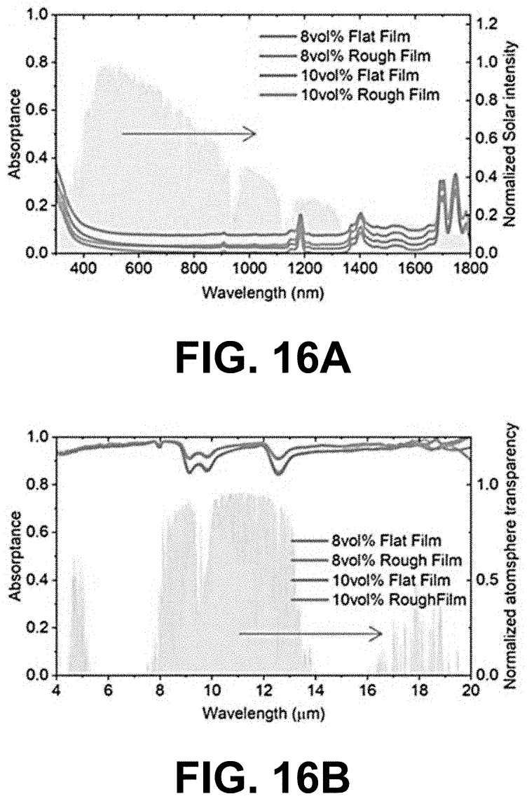

Surface Characterization—Optical Characterization. Uv-Vis and FTIR Spectroscopy were performed to characterize the optical properties of our coatings. FIG. 16A shows the UV-vis spectroscopy for each film. All samples show low absorptance between 400-1100 nm allowing visible light to be transmitted to the solar cell beneath. The rough samples (and high volume percent films) have higher absorptance than the flat samples of the same volume percent. This shows the ability of the microstructure to increase emittance and shows promise for use in radiative cooling.

FIG. 16B shows the FTIR data for each film. All samples have high absorptance with three notable dips at 9.1, 9.8, and 12 μm which matches the atmospheric window (shown in grey). Between the 8 and 10 volume percent samples, the rough samples have higher absorptance than the flat samples and the volume percent of SiO₂ shows no significant impact on absorptance.

Surface Characterization—Outdoor Solar Panel Passive Cooling Tests. All outdoor solar panel tests were conducted in Raleigh, North Carolina (35.77° N-78.68° E). The solar panel test of the 8 volume percent film was conducted on Aug. 9, 2022 which featured rare passing clouds. This experiment begun at 10:30 A.M. and lasted 3 hours with humidity ranging from 66% at the start of the test to 60% at the end. Additionally, outdoor air temperature ranged from 30.5° C. at the start to 34.4° C. at the tests end. The test of the 10 volume percent film was conducted on Sep. 1, 2022 which featured mostly sunny skies with passing clouds. This experiment began at 3:20 P.M. featuring a 3 hour duration, being conducted later in the day as the morning featured completely cloudy skies. The humidity ranged from 38% at the start of the experiment to 50% at the end. Temperature ranged from 90° C. to 29.4° C. with sunset being at 7:42 P.M. in the Raleigh area.

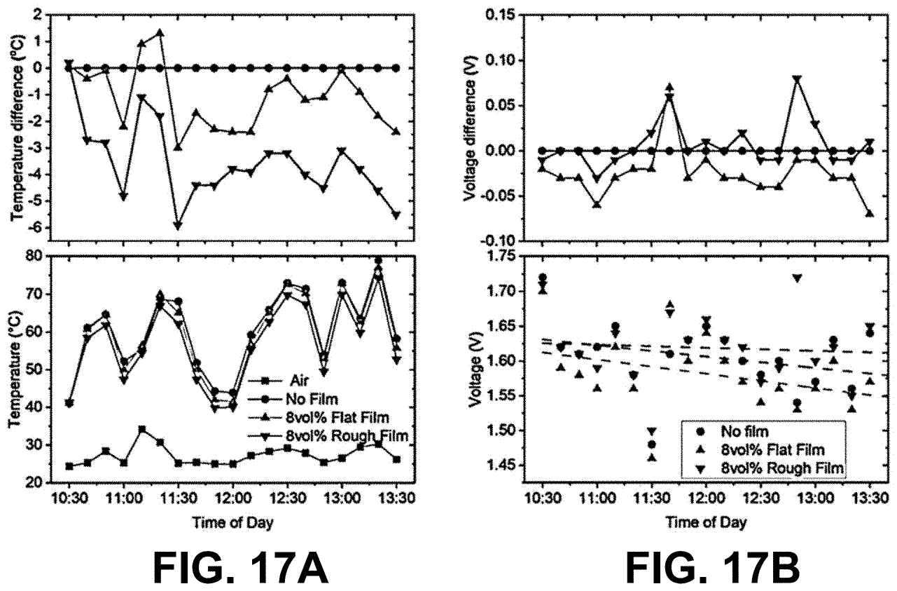

The average temperature difference between the solar panels with 8 volume percent SiO₂/PDMS films and the control with no film was 1.1° C. and 3.5° C. for the flat and rough samples respectively and is shown in FIG. 17A. The temperature difference between the 8 vol % SiO₂ films and control (top) as well as the measured temperature (bottom) are shown over the course of the outdoor test. The temperature of the rough film was consistently lower than the control by 3.5° C. on average. Additionally, the films do not impact the solar panel's ability to generate power. The voltage difference between the solar panels with 8 volume percent films and control was 0.04 volts on average and is shown in FIG. 17B. The voltage difference between the 8 vol % SiO₂ films and control (top) as well as the voltage output from each panel (bottom) are shown over the course of the experiment. The voltage difference between each sample is very small showing the film has no negative impact on power generation.

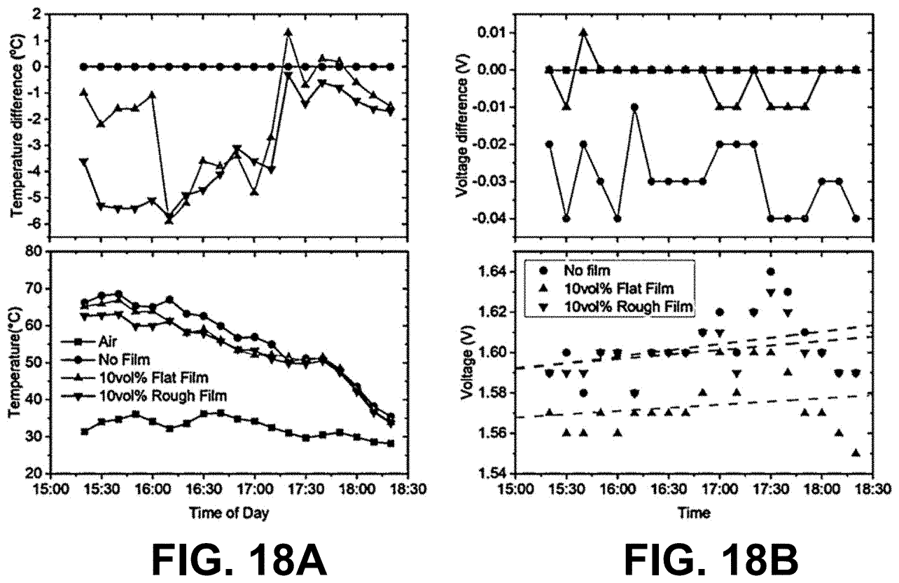

The average temperature difference between the solar panels with 10 volume percent SiO₂/PDMS films and the control was 2.1° C. and 3.3° C. for the flat and rough films respectively and is shown in FIG. 18A. The temperature difference between the 10 vol % SiO₂ films and control (top) as well as the measured temperature (bottom) are shown over the course of the outdoor test. The temperature of the rough film was significantly lower than the control by 4.7° C. for the first half of the test. However, it is notable that the 10 volume percent films show a decrease in temperature difference as the experiment progresses. This is likely because the 10 volume percent films were tested late in the day. As the sun began to set, the films were exposed to less direct sunlight and lost performance. When only the first half of the 10 volume percent experiment is considered, the flat and rough films show a 2.9° C. and 4.7° C. temperature difference below the control respectively. The 10 volume percent films did not impact the power generation of the solar panels and the voltage data is shown in FIG. 18B. The voltage difference between the 10 vol % SiO2 films and control (top) as well as the voltage output from each panel (bottom) are shown over the course of the experiment. The voltage of the rough film was very similar to that of the panel with no film. The rough 10 volume percent film had a voltage that was as much as 0.03 volts higher than the 10 volume percent flat film. It is possible that this could be due to the rough film acting as an anti-reflective coating for the solar cell.

For both volume percents, the rough samples consistently provided a greater temperature difference below the control. This is due to the increased surface area of the rough films which led to greater amounts of radiation being emitted. Furthermore, increased amounts of SiO₂ nanoparticles also contributed to greater temperature differences. Furthermore, it can be expected that at higher temperatures and lower humidity, such as desert or space environments, passive cooling of our films given their parameters could show a stronger impact and positively affect the voltage output.

A composite film was developed that enables the passive cooling of solar panels while having minimal impacts on their power generating efficiency. This film was manufactured utilizing a novel roll coating process. An SiO₂/PDMS nanocomposite polymer-film was produced which included a rough surface topography in order to enhance emittance in mid-IR. The topography of these films was generated by exploiting ribbing instabilities in roll coated polymers. The positive pressure gradient created as a fluid passes between two rollers causes a random microstructure to be formed. Furthermore, the samples with rough surface topography were shown to have high water contact angles promoting anti-fouling merits.

Optically, the films were shown to have high transmission in the visible spectrum while having increased emission in mid-IR. During outdoor testing, it was found that this film can decrease surface temperature of a solar panel by 3.5° C. on average whilst having minimal impact upon the electrical efficiency of the solar cell. The important values of our manufactured composite films can be found in TABLE

TABLE 1

| | 8 Vol % Film | | 10 Vol % Film | |
|---|---|---|---|---|
| Rough Film WCA | 134° | | 136° | |
| Peak Density (Avg) | 4.71 | mm⁻² | 6.162 | mm⁻² |
| Peak Height (Avg) | 456 | μm | 342 | μm |
| Voltage Difference (Avg) | 0.013 | V | 0.003 | V |
| Temperature Difference (Avg) | 3.5° | C. | 3.3° | C. |
| Temperature Difference (Max) | 5.5° | C. | 5.7° | C. |

The manufacturing methods used to create these films are cost effective, scalable, and fast. On a small scale, several films can be made in the span of a few hours and the process could be easily scaled by increasing the size of the manufacturing machine. This solves several problems that are created by traditional manufacturing techniques such as compression molding and photolithography. Furthermore, the roll coated films perform similarly to films made in previous studies which use other more costly manufacturing processes.

Daytime Ambient Passive Radiative Cooling

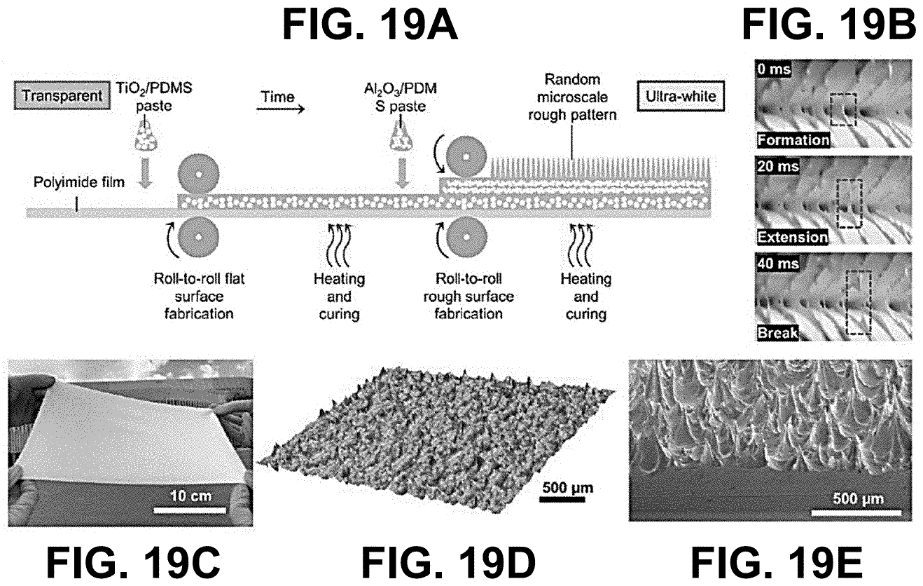

In this study, a template-free roll-to-roll method combined with polymetric nanocomposites is demonstrated to fabricate photonic spike coatings for daytime radiative cooling. FIG. 19A is a schematic diagram illustrating an example of bilayer nanocomposite microstructure photonic coating fabrication. Multilayer structures comprising two or more layers can also be formed. A bilayer or multilayer structure comprising Al₂O₃/polydimethylsiloxane (PDMS) and TiO₂/PDMS enhances the reflectivity of ultraviolet (UV) light. The images of FIG. 19B illustrate spike formation on the photonic coating during the roll-to-roll fabrication process. An image of the photonic coating is shown in FIG. 19C and laser confocal and SEM imaging of the photonic coating are shown in FIGS. 19D and 19E.

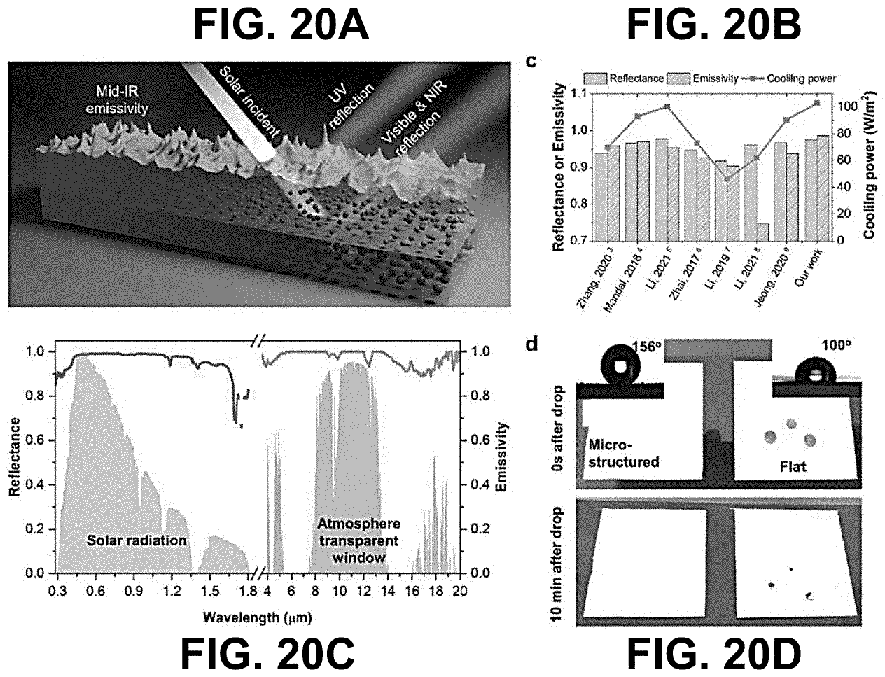

FIG. 20A illustrates the bilayer photonic coating passive resistance cooling, including mid-IR emittance and separately governing the UV. The smaller spheres represent Al₂O₃ and the larger spheres represent TiO₂. The fabricated photonic coatings show an emittance in mid-IR of 98.6% and a state-of-the-art substrate-independent solar radiation reflectance of 97.5%. FIG. 20B shows the spectral reflectance and emissivity of the photonics coating (bilayer, thickness is 300 μm) presenting against normalized ASTM G173-03 Reference Global Tilt Solar Spectra and mid-IR transparent window of Durham, NC, USA. The photonic coating generates a sub-ambient cooling power as high as 99.2 W/m² in the daytime. The building energy modeling result shows a 15.1% cooling system energy (33.4 GJ/year) saving capability across the US. Compared with the state-of-the-art radiative cooling materials. FIG. 20C compares the solar reflectance, emissivity, and theoretical cooling power (normalized in the same ASTM G173-03 Reference Global Tilt Solar Spectra and atmospheric transparent window of Durham, NC, USA.) with the state-of-the-art radiative cooling materials record in the reference, the photonics coating possesses a high solar reflectivity, thermal emissivity, and cooling power. Besides, the photonic coating possesses superhydrophobic merit (water contact angle=156°), promoting contamination resistance as demonstrated with 30° slope as shown in FIG. 20D.

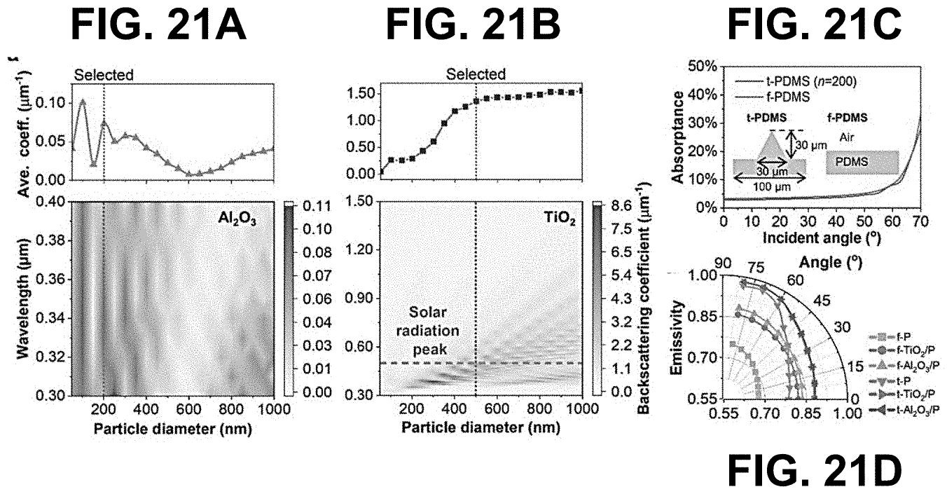

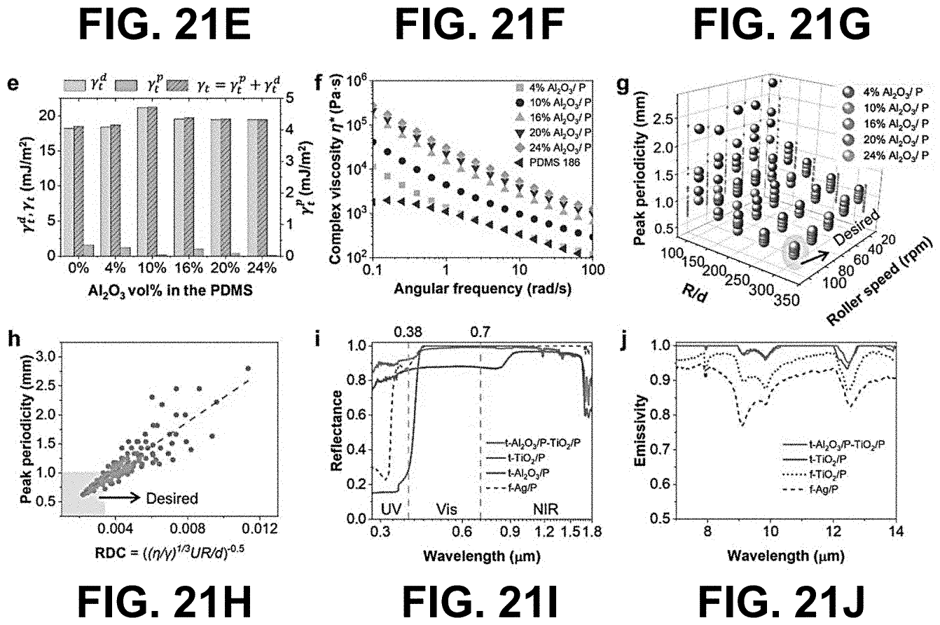

The ideal radiative cooling materials should possess high solar reflectivity and thermal emissivity. The transparent PDMS is used for high thermal emission. TiO₂ and Al₂O₃ nanoparticles are mixed with PDMS to enhance solar reflectivity. TiO₂ is a commercial white painting material with high reflectivity at a thin thickness due to its high refractive index (about 2.7). However, the TiO₂ highly absorbs the UV and blue light due to the 3.0 eV bandgap (413 nm), which limits the solar reflectivity below 91% 27. Low-cost Al₂O₃ nanoparticles were introduced to suppress UV absorptivity to tackle this challenge. The final design of the bilayer photonic materials is shown in FIGS. 19A and 20A. The Al₂O₃/PDMS is layered on top of the TiO₂/PDMS to prevent the UV absorption of TiO₂. Theoretically, higher backscattering coefficients of the nanoparticles lead to higher reflectivity. The backscattering coefficients of the nanoparticles were calculated by Mie's theory and shown in FIGS. 21A and 21B (particles concentrations were 25 vol %, “Selected” marked the particles size in final product). FIG. 21A shows the Al₂O₃ nanoparticles' average backscattering coefficient, and the backscattering coefficient along the change of the particle diameter and wavelength at UV range, FIG. 21B shows the TiO₂ nanoparticles' average backscattering coefficient, and the backscattering coefficient along the change of the particle diameter and wavelength at solar spectra range. 500 nm sized TiO₂ was chosen as it has a strong backscattering coefficient peak at the peak of solar radiation (500 nm). 200 nm sized Al₂O₃ was chosen due to its high backscattering coefficient in the UV range and better processability in PDMS compared to 100 nm sized Al₂O₃ particles.

Besides the improved solar reflectivity, the thermal emissivity was elevated by fabricating the spike microstructures on the top surface of the coating. The spike microstructures (about 30 μm lateral length) only had a negligible effect on the solar spectrum reflectivity by Rigorous Coupled-Wave Analysis (RCWA) as shown in FIG. 21C (t-denotes a triangular spike model, and f- denotes the flat model), because of the large mismatch between the wavelength of the incident light and the structure size. The spike microstructures create a gradual refractive index change at the air/coating interface, which enhances the thermal emissivity. The enhancement of the thermal emissivity by the photonic microstructures was simulated by finite element analysis (FEA, COMSOL Multiphysics 5.5). The FEA demonstrates that the microstructures significantly increase the hemisphere emissivity from 70.8% (flat PDMS, f-P) to 87.0% (triangular microstructured PDMS, t-P) at mid-IR. FIG. 21D shows the enhancement results for the mid-IR emissivity by the photonic microstructures simulated by finite elements analysis (FEA, COMSOL, particles concentration was 25 vol %. The triangular microstructure also shows higher emissivity than square and circular topographies. Boosted by the strong mid-IR absorption of Al₂O₃ or TiO₂ nanoparticles (25 vol % particle concentration), the emissivity can be promoted further to 92.9% as illustrated in FIG. 21D. The simulation results also reveal that the higher height and lower peak periodicity (denser) of the spike lead to a higher emissivity, which guides our roll-to-roll fabrication.

For cooling energy-saving applications, the radiative cooling photonic coating materials will need to be fabricated on a large scale. The rapid roll-to-roll method fabricates the TiO₂/PDMS and Al₂O₃/PDMS bilayer photonic coating materials with spike microstructures by employing viscoelastic fluid instability. The formation of the spike peaks is described in 19B (15 vol % Al₂O₃/PDMS, relatively low viscosity and low roller speed are utilized). Previous simulation research demonstrated that surface energy γ, viscosity η (or complex viscosity η*), roller radius R, roller distance or gap d, and roller speed U strongly correlated with the pressure gradient in the flow direction, which directly led to the formation of the spike “defects”. To demonstrate the effects of η, U, γ, and R/d on the final spikes' peak periodicity (pₛₚᵢₖₑ), parametric experiments are conducted with U ranging from 20 rpm to 100 rpm, and R/d from 100 to 320. The 4-24 vol % Al₂O₃/PDMS nanocomposites are prepared for different viscosities. The γ and η* measurement results of the nanocomposites are shown in FIGS. 21E and 21F. FIG. 21E shows the surface energy components (polar, γₜ^{d}, disperse, γₜ^{p}, total, γₜ=γₜ^{p}+γₜ^{d}) of the different Al₂O₃ (200 nm) particle concentrations in PDMS (P), and FIG. 21F shows the complex viscosity (η*) vs. angular frequency. The parametric roll-to-roll experiment results demonstrate that the higher η (higher particle content), U, and R/d would lead to a smaller pₛₚᵢₖₑ as shown in FIG. 21G. The capillary number (Cₐ=ηU/γ, used to be the index for predicting the critical point of the roll-to-roll defect appearance, but the fabrication in this study is far beyond this point) could not fit the viscoelastic fluid fabrication very well. A novel Roll-to-roll Defects Coefficient, RDC=((η/γ)^{1/3}UR/d)^{-0.5}, is proposed to fit with the pₛₚᵢₖₑ. The pₛₚᵢₖₑ vs. RDC result is shown in FIG. 21H. A linear proportion shows that the pₛₚᵢₖₑ decreased as the RDC decreased.

In the final bilayer products, a flat 25 vol % TiO₂/PDMS is first roll-to-roll fabricated and cured. Then, the top layer is fabricated on the flat layer by roll-to-roll method, where the 26 vol % Al₂O₃ and 3 vol % SiO₂ (10 nm, stabilization particles) are mixed into PDMS to achieve close-boundary viscosity but with processability. When U went to 100 rpm and the R/d went to 320, the about 100 μm pₛₚᵢₖₑ is achieved (FIGS. 19D and 19E), which is desired for improving thermal emissivity.

It is necessary to characterize the optical properties of solar and mid-IR ranges to prove the radiative cooling capability of the photonic coating. The ultraviolet-visible (UV-vis) and Fourier transform infrared (FTIR) spectrometers characterize solar reflectivity and mid-IR thermal emissivity, respectively. In FIG. 21I, the UV-vis results show that the bilayer Al₂O₃/PDMS-TiO₂/PDMS coating overcomes the drawbacks of the Al₂O₃/PDMS (low overall reflectivity, 89.5%) and TiO₂/PDMS (high absorption at UV). A state-of-the-art 97.5% solar energy reflectance is achieved, which is comparable with PDMS/silver. The FTIR measurement verified that the spike structure enhanced the mid-IR emission (FIG. 21J). A 98.6% emissivity is obtained from the structured bilayer Al₂O₃/PDMS-TiO₂/PDMS and the structured TiO₂/PDMS samples. The referenced materials, flat TiO₂/PDMS and flat PDMS, only achieve 93.5% and 89.0% emissivity, respectively. Such prominent optical properties of the photonic coatings guarantee a potential theoretical daytime radiative cooling performance of 102.9 W/m².

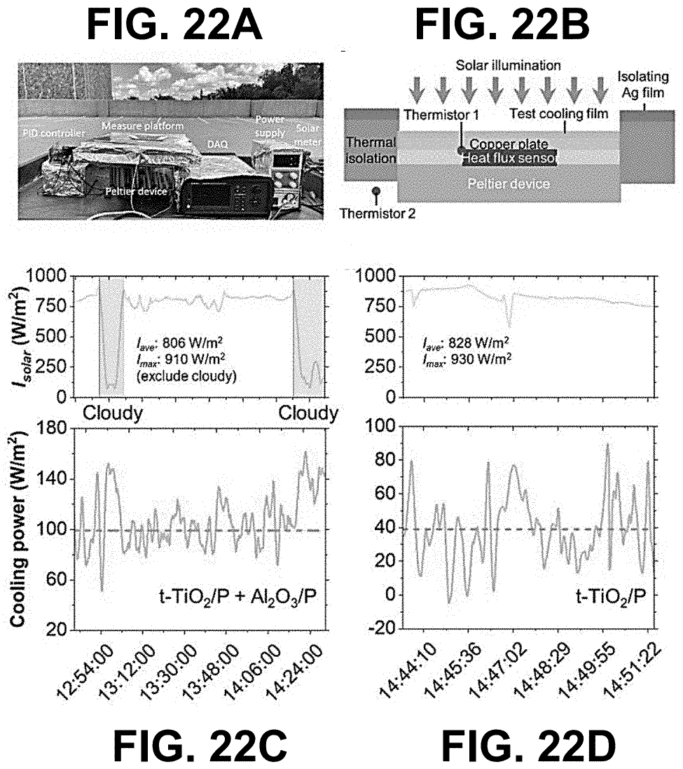

To measure the daytime radiative cooling performance of the sample, a Peltier-based measurement platform was set up in Durham, NC. The measurement included a Peltier device, a PID controller, a data acquisition (DAQ) system, a power supply, and a thermopile pyranometer as shown in the image of FIG. 22A and the schematic diagram of FIG. 22B. The outdoor measurement was conducted in Durham on Jun. 24, 2022. Even if the temperature and solar radiation were as high as 32° C. and 806 W/m² in the summer noon (solar illumination and cooling power of FIG. 22C), the photonic coatings still achieved 99.2 W/m² averaged cooling power from 12:40 PM to 2:30 PM (excluding the cloudy periods), which matched the theoretical calculation results (102.9 W/m²). It is worth noting that there were two partially cloudy periods during measurement (from 12:55 PM to 1:04 PM, and 2:17 PM to 2:30 PM) when pieces of small clouds only blocked the sun but not the entire view of the sky. During these periods, the measured cooling power was significantly elevated to about 130 W/m², because most of the solar heating was contributed by direct solar radiation. Hence, significant solar heating was restricted by a small cloud. However, given the broad-angle high emissivity of the nanophotonic coatings (solar illumination and cooling power of FIG. 22D), the screening of the mid-IR radiation by the small clouds covering the sun was negligible. This cooling power elevating result also matched the experiment recorded in the reference, which suggested filtering out the directional solar radiation further improves daytime radiative cooling power. The further test of the reference sample (TiO₂/PDMS) cooling performance showed the benefit of having Al₂O₃ nanoparticles in the upper layer to scatter the UV radiation. The TiO₂/PDMS could only get cooling power as low as 39.0 W/m² due to the UV part absorption (FIG. 22D). The outdoor measurements demonstrated the efficacy of photonic design for boosting the daytime radiative cooling performance.

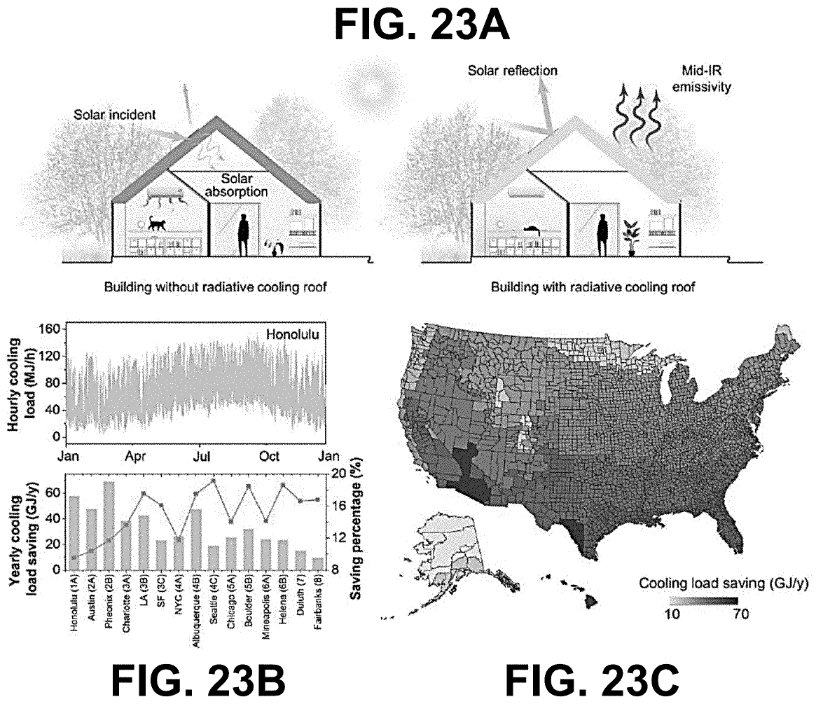

Inspired by the radiative cooling and self-cleaning capability, it is proposed that the bilayer photonic coatings can serve as the efficient radiative coatings of the roofs for cooling energy saving in buildings as illustrated in FIG. 23A. To quantitatively demonstrate the photonic coatings' scale-up impact on the building cooling efficiency, EnergyPlus with experimental measured materials' optical properties was imported to simulate the potential all-year cooling energy saving of the buildings across the US based on a scenario with mid-rise apartments. 15 cities corresponding to 15 climate zones in the US were chosen to calculate the cooling energy 7,28,30. Compared with the baseline, buildings with radiative cooling roofs save energy up to 68.91 GJ/year in Phoenix, which constitutes 11.7% of the year-round cooling energy in the baseline buildings (FIG. 23B). As shown in the cooling energy saving map of FIG. 23C, the cooling materials benefit more in the hot and dry areas: 57.7 GJ/year in Honolulu (Climate zone number: 1A), 47.5 GJ/year in Austin (2A), 68.9 GJ/year in Phoenix (2B) and 42.6 GJ/year in LA (3B). Even if the temperature and solar radiation are high in these areas, the radiative cooling materials perform better because they reflect sunlight nearly perfectly and radiate more heat to the deep universe through the clear sky. However, the saving amount gradually decreases when the cooling materials are exposed to the weather in the cold areas: 9.7 GJ/year in Fairbanks (8) and 15.1 GJ/year in Duluth (7). It is because the cooling load is small in cold weather. Since the radiative photonic coating provides all-day cooling power when space cooling is needed, by coating the roof with our radiative cooling photonic coatings, about 33.4 GJ/year cooling energy may be saved (on average) over the entire US. It is also 15.1% of the year-round US cooling energy.

In this research, low-cost and scalable high-performance passive radiative cooling microstructured photonic coatings were fabricated by a roll-to-roll method. By controlling the nanocomposite's viscosity and fabricating parameter (roller gap and speeds), periodical spike microstructures were generated in the roll-to-roll process, which endowed the materials with 98.6% emissivity and strong self-cleaning capability. A novel Roll-to-roll Defect Coefficient (RDC) was proposed to predict the peak periodicity by materials' viscoelastic properties and fabrication parameters. Such a photonic coating showed a 99.2 W/m² average cooling power under direct sunlight. Benefiting from the high cooling power, scalable fabrication, and superhydrophobic properties, the coating was proposed to serve as the cooling roof. 15.1% of the year-round cooling energy saving around the US was demonstrated by numerical simulation.

More importantly, this fabrication method is compatible with any viscous composite paste and makes the scalable application of the photonic coatings possible. This research could potentially serve as a platform for broadening the applicability of traditional roll-to-roll fabrication and inspiring technological advancement in radiative cooling materials.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method comprising:
forming a viscoelastic material coating; and
forming micro-scale and/or nano-scale 3D features on a surface of the viscoelastic material coating, the micro-scale and/or nano-scale 3D features formed under shearing stress using a roll-to-roll process without a template.

2. The method of claim 1, wherein the micro-scale and/or nano-scale 3D features comprise a semi-regular geometry.

3. The method of claim 2, wherein the micro-scale and/or nano-scale 3D features comprise ribbing instabilities or riblets.

4. The method of claim 3, wherein microstructures of the ribbing instabilities or riblets have a spacing in a range from about 25 μm to about 700 μm, or in a range from about 50 μm to about 500 μm.

5. The method of claim 3, wherein microstructures of the ribbing instabilities or riblets have a spacing in of about 100 μm or less.

6. The method of claim 1, wherein the viscoelastic material is a viscoelastic polymer.

7. The method of claim 6, wherein the viscoelastic polymer comprises polydimethylsiloxane elastomer (PDMS), polyurethane, polyethylene, or polyamide.

8. The method of claim 6, wherein the viscoelastic polymer comprises a fluoropolymer.

9. The method of claim 6, wherein the viscoelastic polymer is a viscoelastic polymer nanocomposite.

10. The method of claim 9, wherein the viscoelastic polymer nanocomposite comprises PDMS and carbon nanotubes (CNTs), PDMS and silicon dioxide (SiO₂) nanoparticles, or PDMS and titanium dioxide (TiO₂) nanoparticles, or PDMS and aluminum oxide (Al₂O₃) nanoparticles.

11. The method of claim 8, wherein the viscoelastic polymer nanocomposite comprises 3.5 wt % of CNTs.

12. The method of claim 1, wherein the surface comprising the micro-scale and/or nano-scale 3D features exhibits a Wenzel roughness factor of about 1.6 or greater.

13. The method of claim 1, forming the viscoelastic material coating comprises synthesizing a nanocomposite paste comprising a viscoelastic polymer and nanoparticles.

14. The method of claim 13, wherein the viscoelastic polymer is a polydimethylsiloxane elastomer (PDMS).

15. The method of claim 13, wherein the nanoparticles comprise carbon nanotubes (CNTs), silicon dioxide (SiO₂) nanoparticles, titanium dioxide (TiO₂) nanoparticles, or aluminum oxide (Al₂O₃) nanoparticles.

16. The method of claim 1, wherein the micro-scale and/or nano-scale 3D features formed by passing the viscoelastic material coating through a two roll coating machine.

17. The method of claim 16, comprising controlling riblet spacing of the micro-scale and/or nano-scale 3D features by controlling roller speed, roller distance, or both of the two roll coating machine.

18. The method of claim 1, wherein the viscoelastic material coating with the micro-scale and/or nano-scale 3D features is disposed on a film, substrate or photovoltaic device.

19. The method of claim 1, comprising disposing the viscoelastic material coating on another material layer prior to forming micro-scale and/or nano-scale 3D features on a surface of the viscoelastic material coating, thereby forming a bilayer or multilayer coating.

20. The method of claim 19, wherein the other material layer comprises a viscoelastic material.
